(19) United States
(12) Patent Application Publication
(10) Pub. No.: US 2006/0284871 A1
(43) Pub. Date: Dec. 21, 2006

(54) Systems and methods for generating and measuring surface lines on mesh surfaces and volume objects and for mesh cutting techniques ("curved measurement")

(75) Inventors: Chia Wee Kee, (US); Chen Tao, (US)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, s.p.a., Milano (IT)

(21) Appl. No.: 11/288,567

(22) Filed: Nov. 28, 2005

Related U.S. Application Data
(60) Provisional application No. 60/631,161, filed on Nov. 27, 2004.

(51) Int. Cl. G06T 17/20; G06T 15/30; G06T 15/10; G06T 15/20

(52) U.S. Cl. 345/423; 345/427

(57) ABSTRACT

Systems and methods are presented for generating surface lines on mesh surfaces and voxel objects. In exemplary embodiments of the present invention directed to mesh surfaces, such methods include preprocessing a triangle mesh data structure, constructing a grid data structure for the triangle mesh object, representing a relationship of triangles and vertices, determining boundary edges and vertices, computing a series of surface points, and generating a surface line. In exemplary embodiments of the present invention this technique can be used to cut a mesh surface along the line generated. In exemplary embodiments of the present invention a surface line can be generated from start point A to end point B along an arbitrary curved surface based on the start point and the direction of a vector from the start point to the end point. In such embodiments a point having a small displacement away from the start point can be defined as a reference point, and such reference point can be rotated along an axis defined by the normal of a defined plane to obtain an initial surface point. By repeating the above process using each obtained surface point as a new start point a surface line can be generated from point A to point B on a voxel object's surface. In exemplary embodiments of the present invention such surface lines can be used to perform measurements of volumes of such voxel objects.

### CROSS-REFERENCE TO RELATED APPLICATIONS

This application claims the benefit of U.S. Provisional Patent Application No. 60/631,161, filed on Nov. 27, 2004. The disclosure of said provisional patent application is hereby incorporated herein by reference as if fully set forth.

### TECHNICAL FIELD

The present invention relates to the interactive display of 3D data sets, and more precisely to a system and method for generating and measuring surface lines on mesh surfaces and volume objects.

### BACKGROUND OF THE INVENTION

Measurement of the linear distance between points in a volume is a useful quantitative tool in medical visualization. However, the measurement of an absolute linear distance between points in 3D space may not always be sufficient. Often what is needed is the ability to measure distances on the surface of an object itself, such as, for example, when measuring the size of a proposed craniotomy during surgical planning, or when planning graft of skin tissue from one area of the body to another. Such surface measurements may yield other useful information about a volumetric object such as, for example, a change in an object's size along part of its surface over time, such as, for example, a diameter of a melanoma, or the length of a scar or wrinkle.

Conventional approaches to measurement of a line along a surface of an object involve approximating such a measurement by making multiple small linear measurements across the object's surface. However, this approach can be inaccurate and time consuming to perform. Where an object surface has multiple curves, it can be difficult to correctly place such linear measurements so as to accurately approximate the actual surface measurements.

Thus, most current software only allows taking measurements on a 2D data slice. Such surface measurements, being constrained to a single plane do not easily allow the user to make surface measurements between arbitrary points in the 3D domain.

What is needed in the art is a convenient method for taking measurements along a line which is restricted to the surface of a given object.

### SUMMARY OF THE INVENTION

Systems and methods are presented for generating surface lines on mesh surfaces and voxel objects. In exemplary embodiments of the present invention directed to mesh surfaces, such methods include preprocessing a triangle mesh data structure, constructing a grid data structure for the triangle mesh object, representing a relationship of triangles and vertices, determining boundary edges and vertices, computing a series of surface points, and generating a surface line. In exemplary embodiments of the present invention this technique can be used to cut a mesh surface along the line generated. In exemplary embodiments of the present invention a surface line can be generated from start point A to end point B along an arbitrary curved surface based on the start point and the direction of a vector from the start point to the end point. In such embodiments a point having a small displacement away from the start point can be defined as a reference point, and such reference point can be rotated along an axis defined by the normal of a defined plane to obtain an initial surface point. By repeating the above process using each obtained surface point as a new start point a surface line can be generated from point A to point B on a voxel object's surface. In exemplary embodiments of the present invention such surface lines can be used to perform measurements of volumes of such voxel objects.

### BRIEF DESCRIPTION OF THE DRAWINGS

FIG. 1 depicts placement of an exemplary starting point for making a curved measurement according to an exemplary embodiment of the present invention;

FIG. 2 depicts placement of an exemplary end point for making a curved measurement according to an exemplary embodiment of the present invention;

FIG. 3 depicts generation of an examplary curved line on an exemplary surface according to an exemplary embodiment of the present invention;

FIG. 4 depicts generation of an examplary curved line across a mesh boundary on an exemplary surface according to an exemplary embodiment of the present invention;

FIG. 5 depicts generation of an examplary curved line across multiple mesh boundaries on an exemplary surface according to an exemplary embodiment of the present invention;

FIG. 6 depicts obtaining an initial reference point for generating a line on a voxel surface according to an exemplary embodiment of the present invention;

FIG. 7 depicts performing an initial rotation of the reference point of FIG. 6 according to an exemplary embodiment of the present invention;

FIGS. 8(a) and (b) depict performing forward scanning from the reference point of

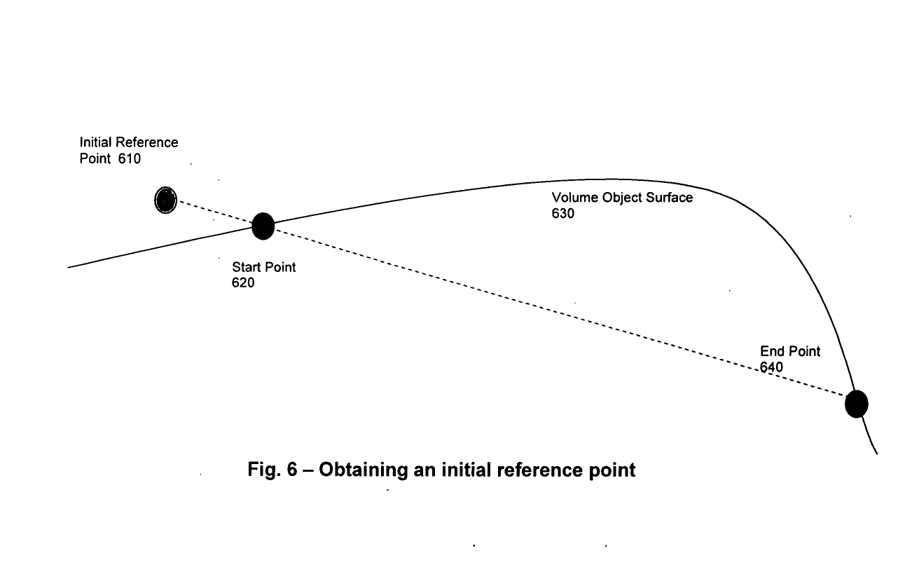

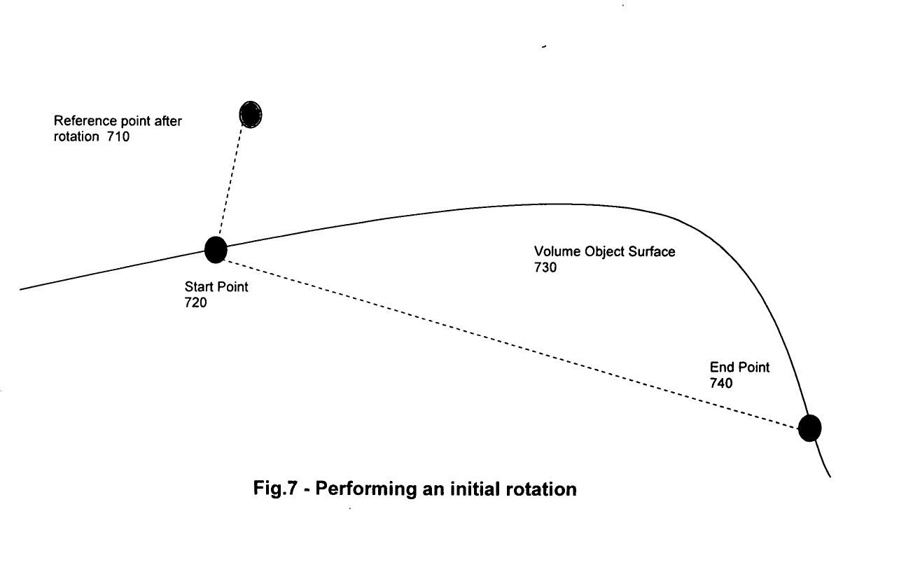

FIGS. 6 and 7 and detection of an exemplary voxel volume surface point according to an exemplary embodiment of the present invention;

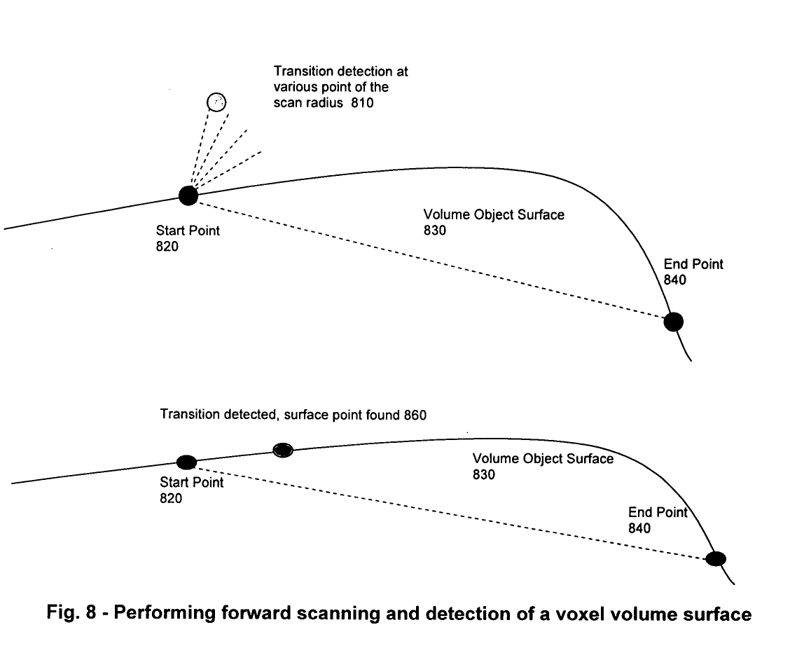

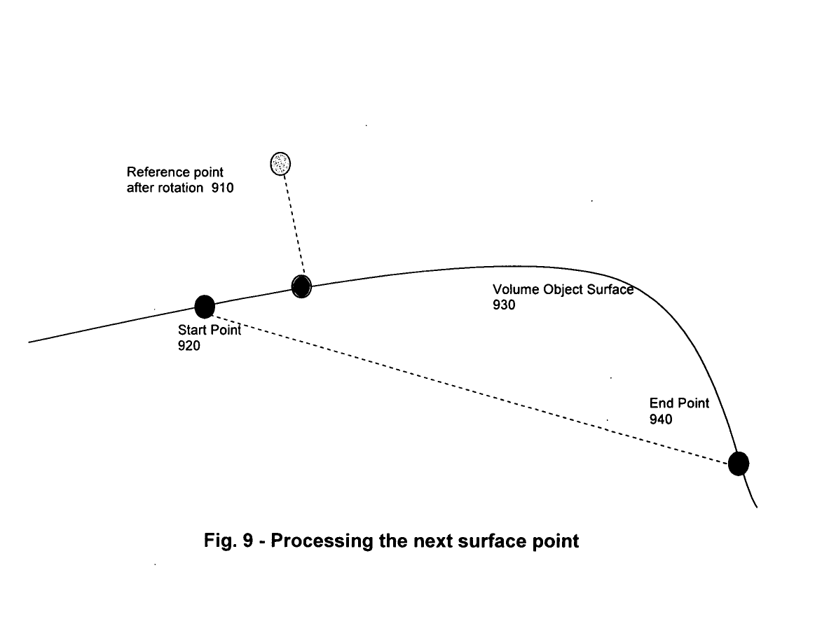

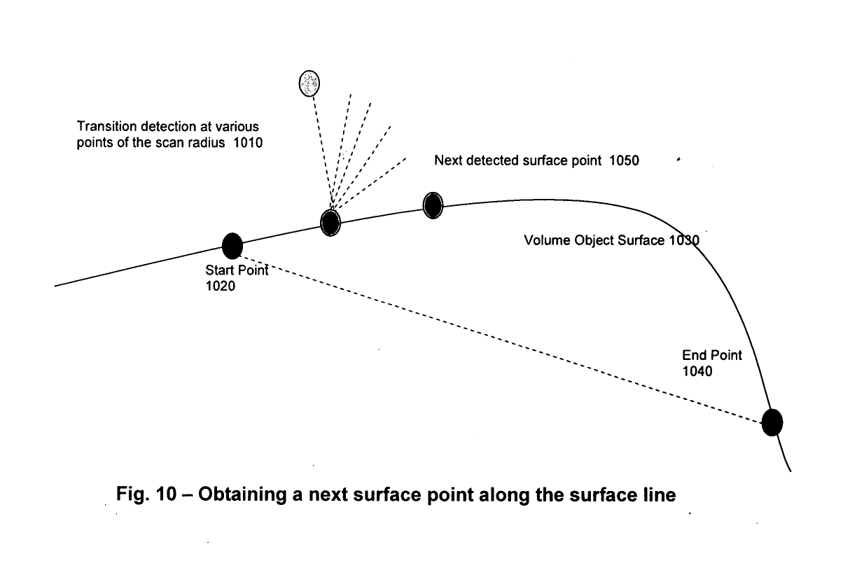

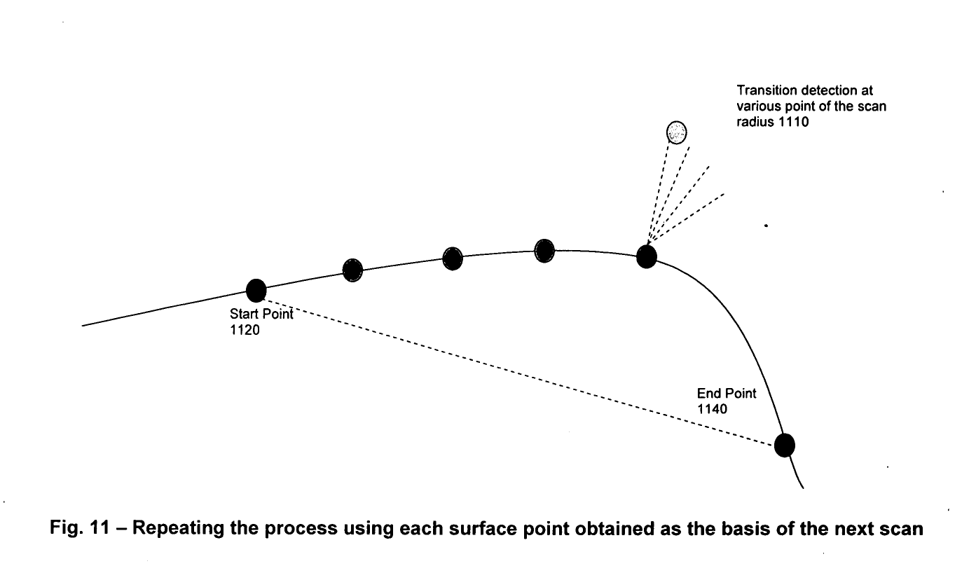

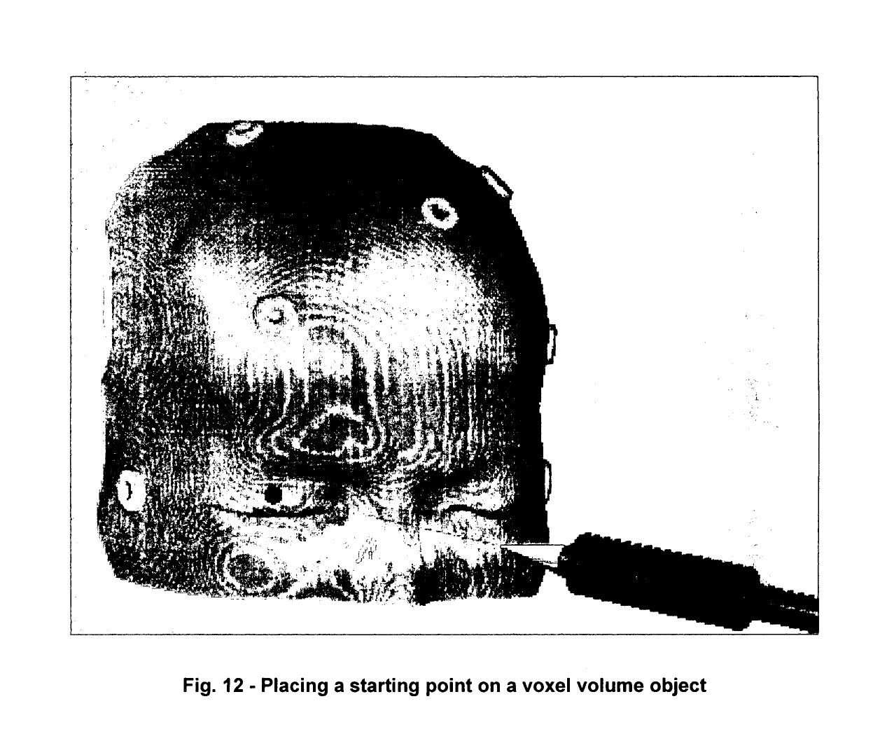

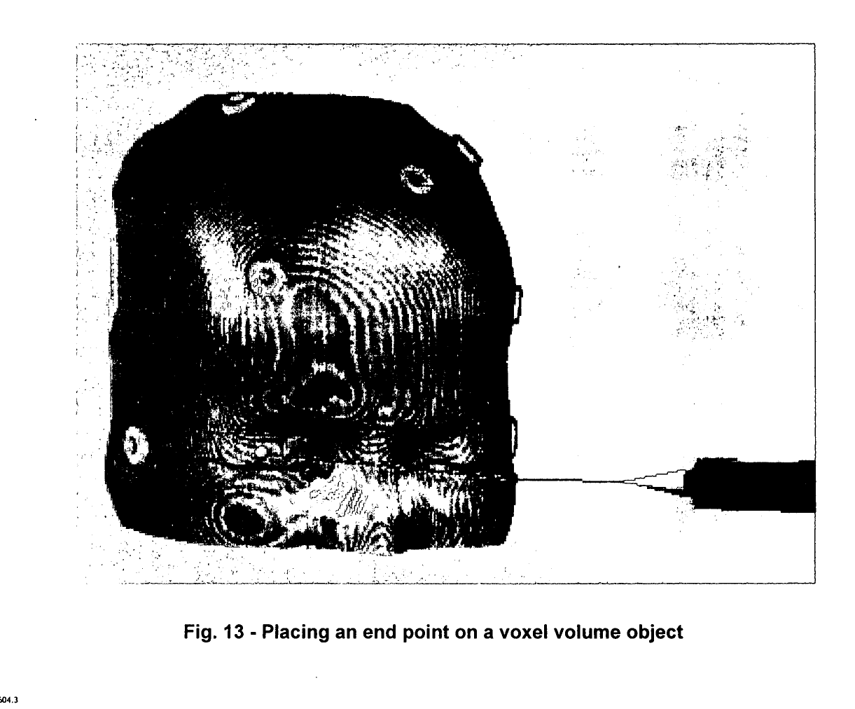

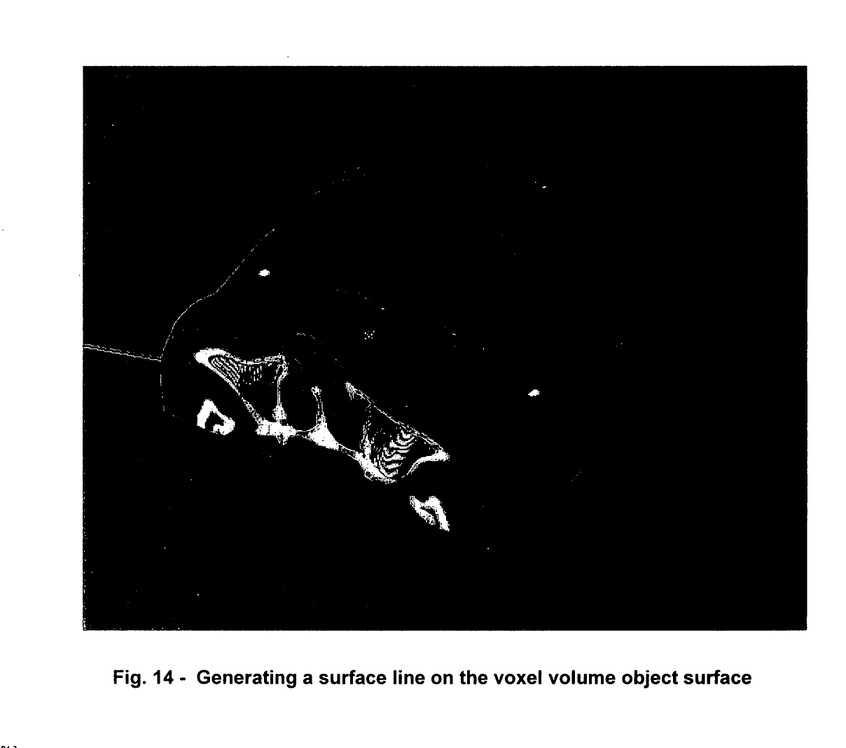

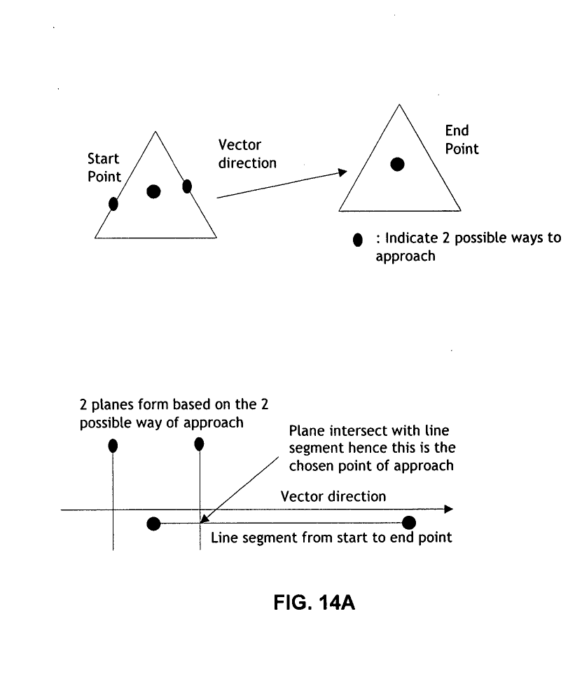

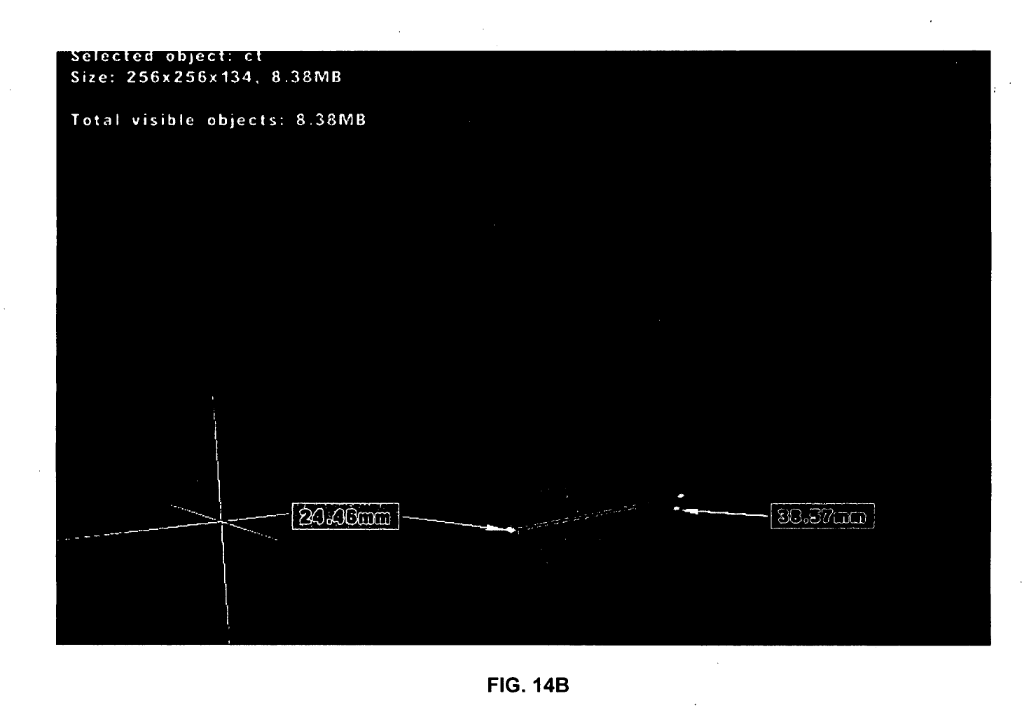

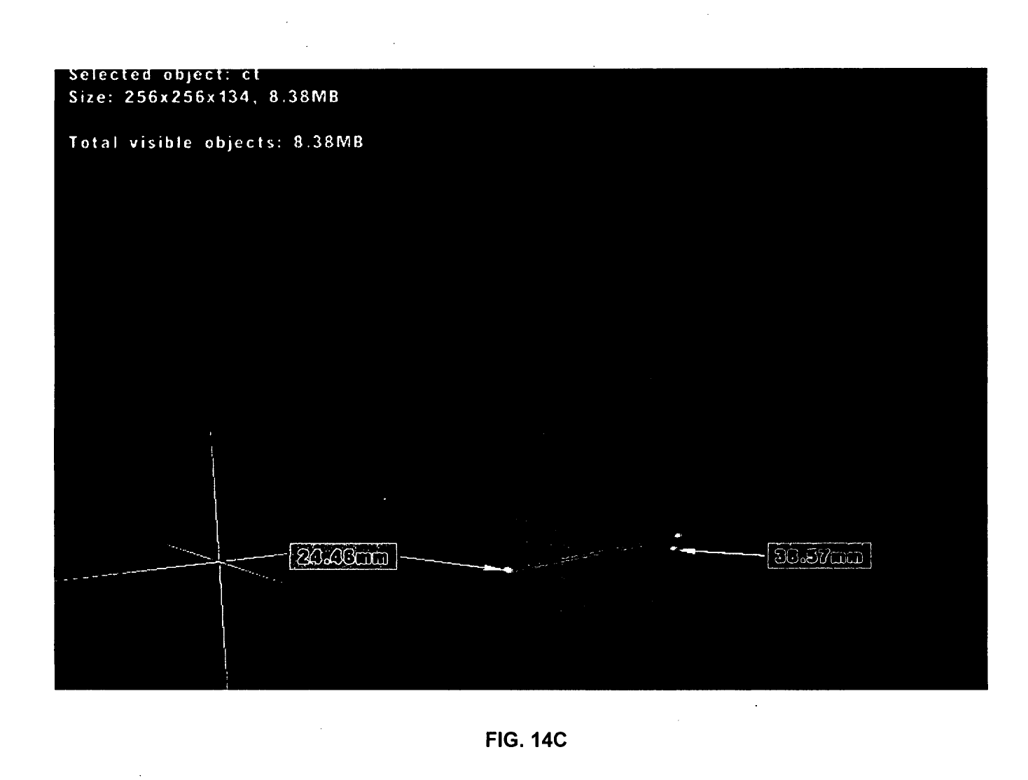

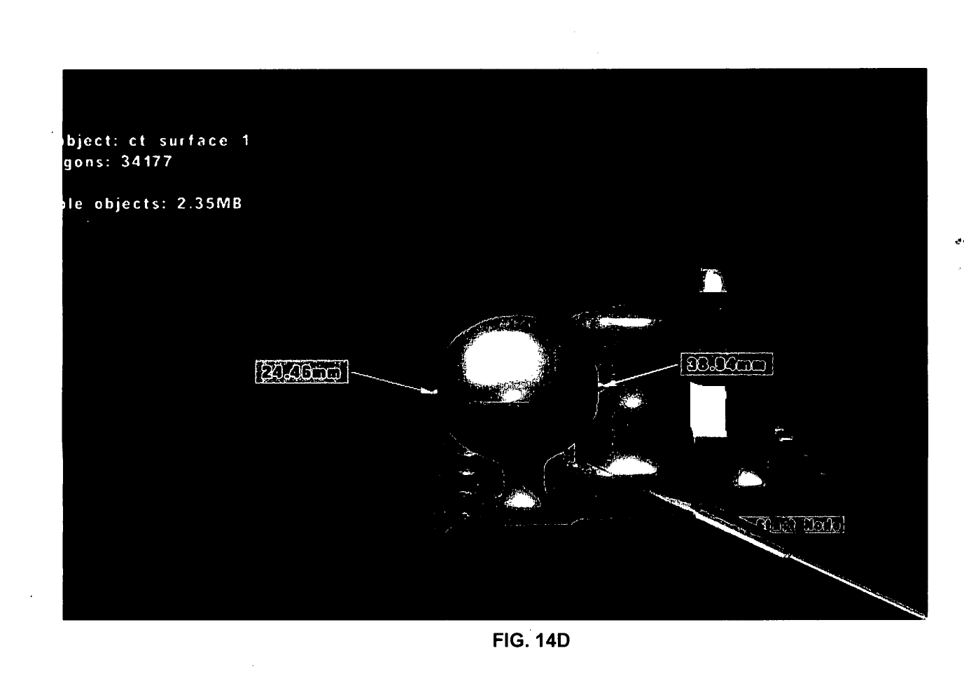

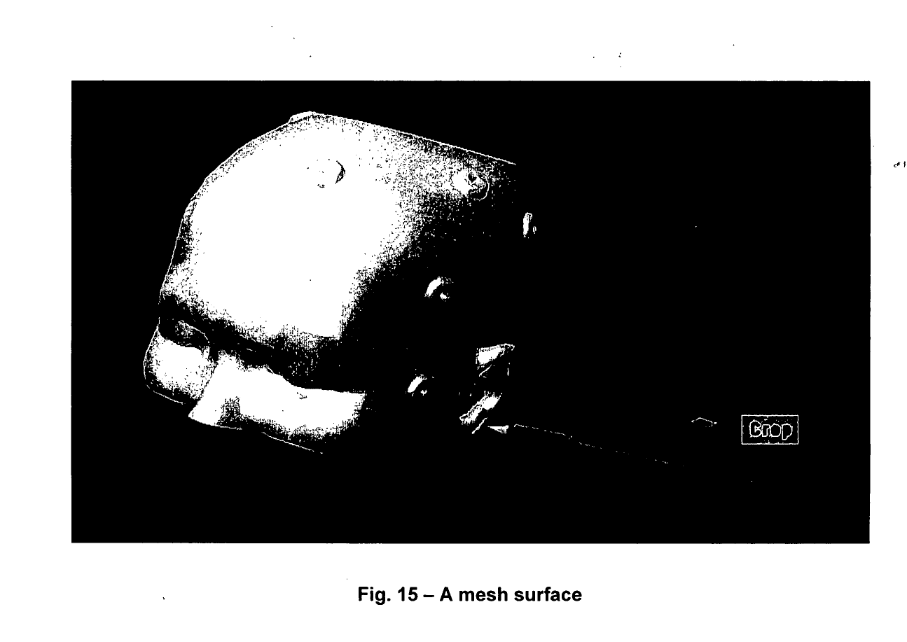

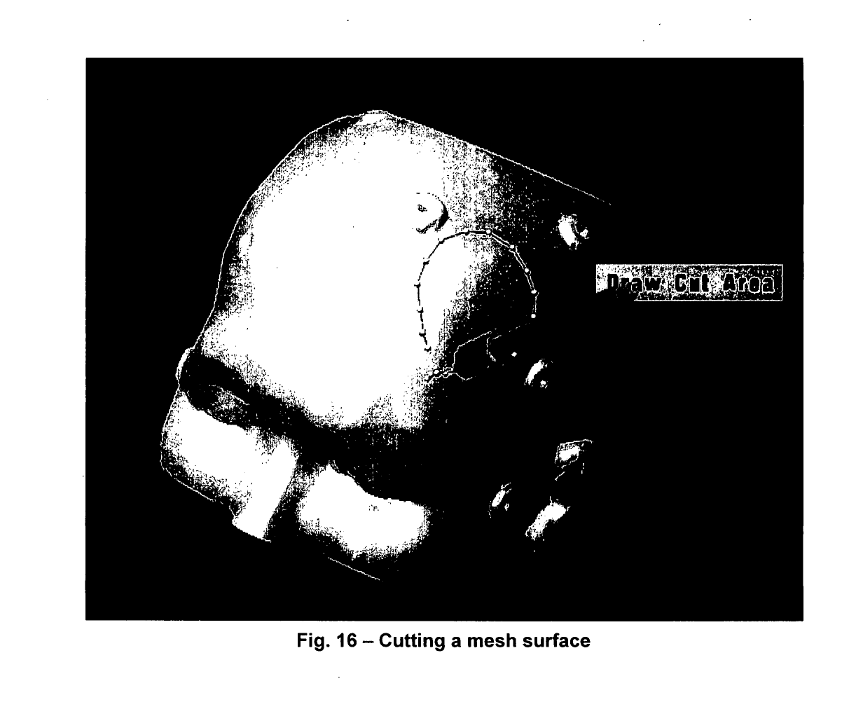

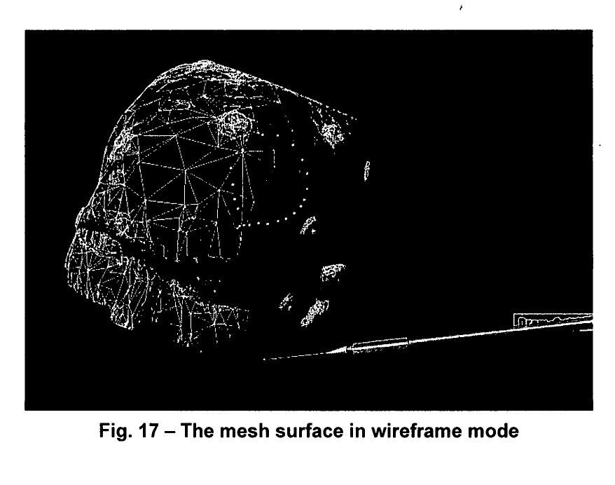

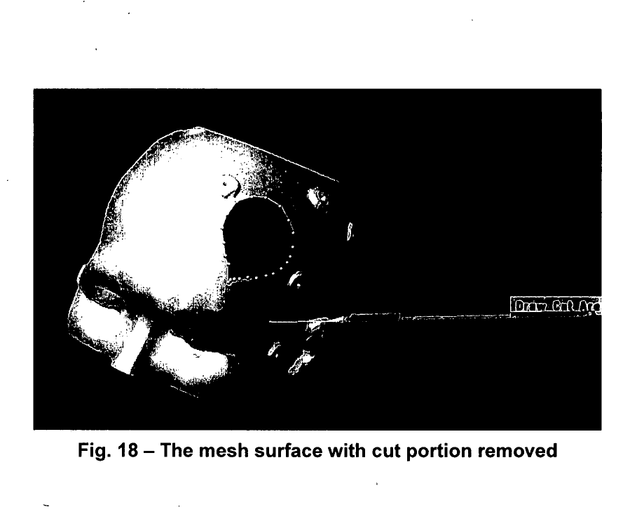

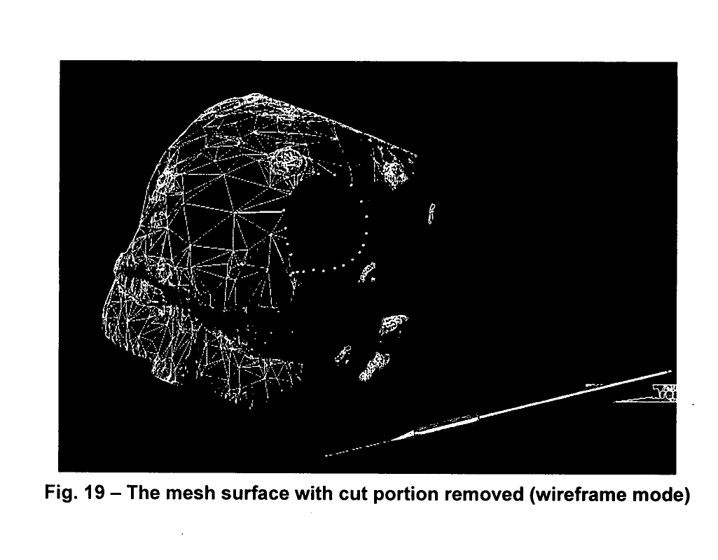

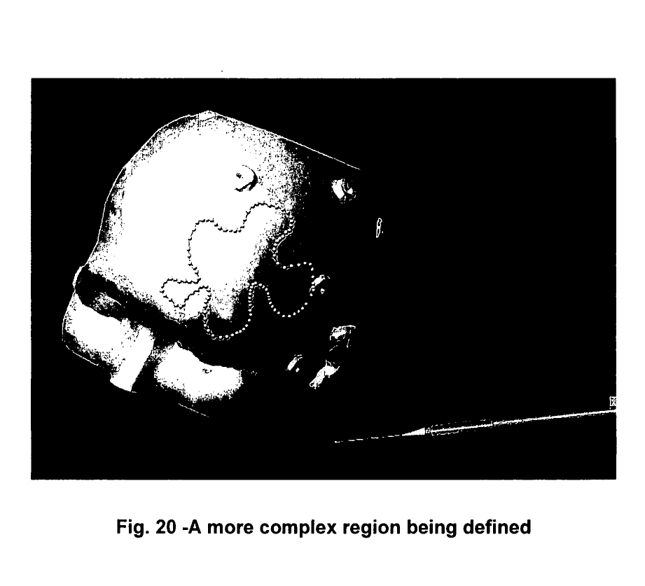

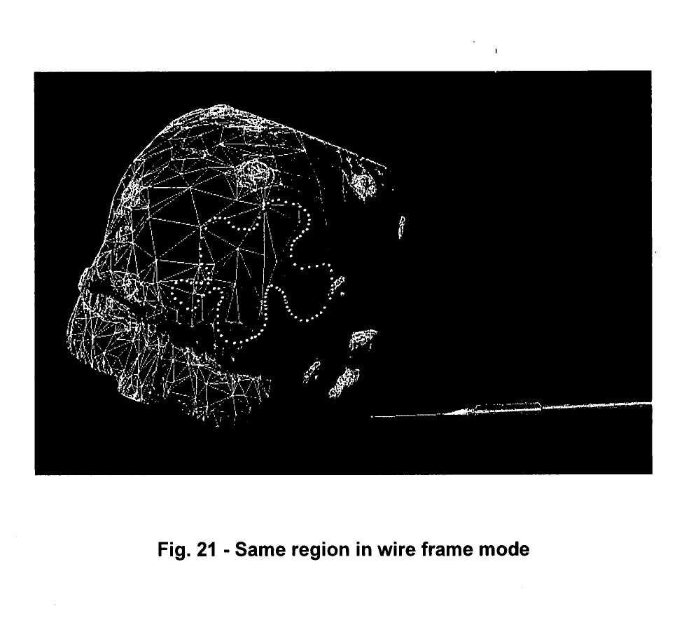

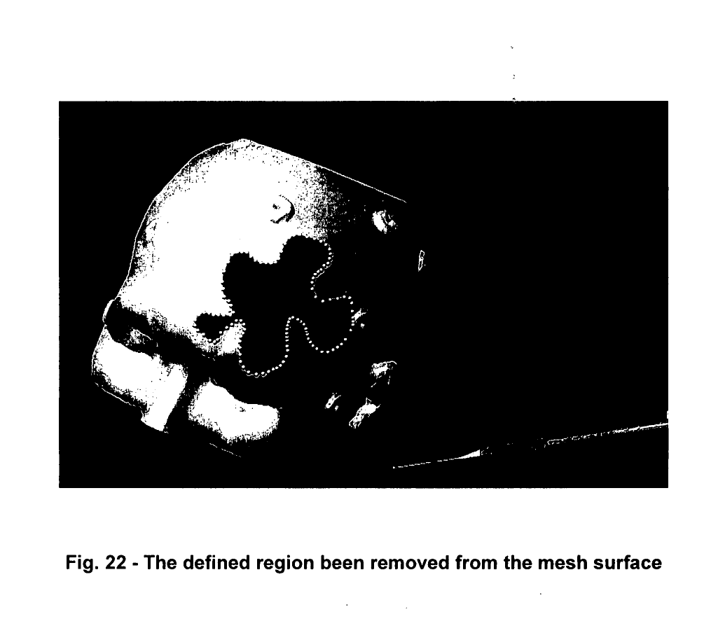

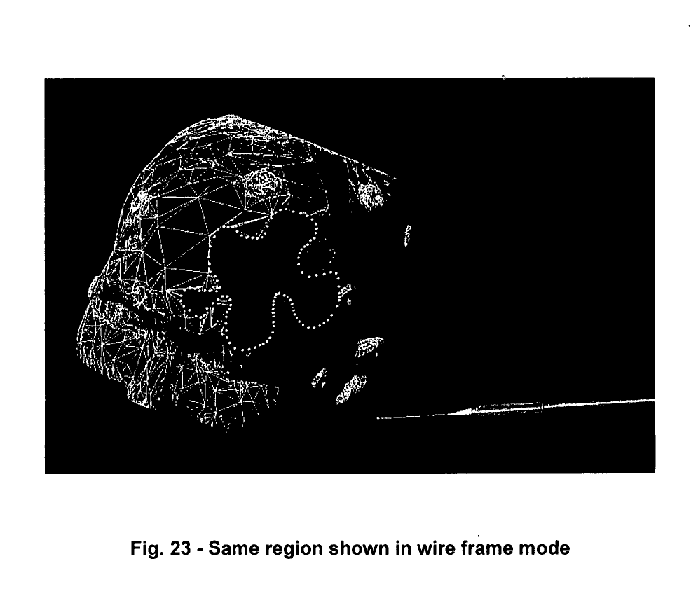

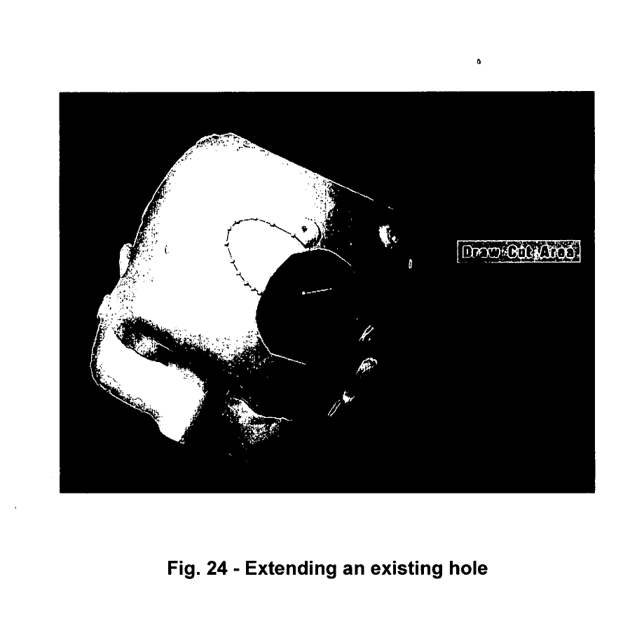

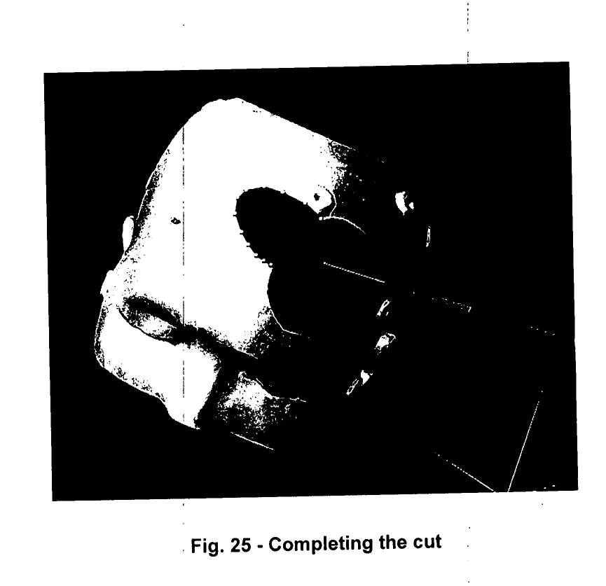

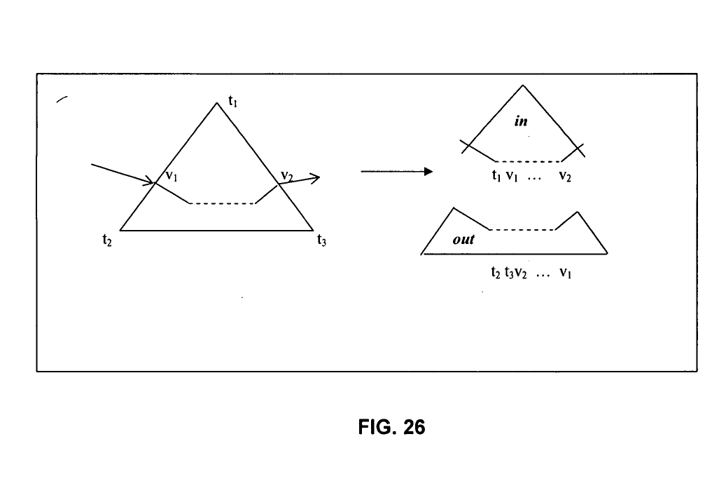

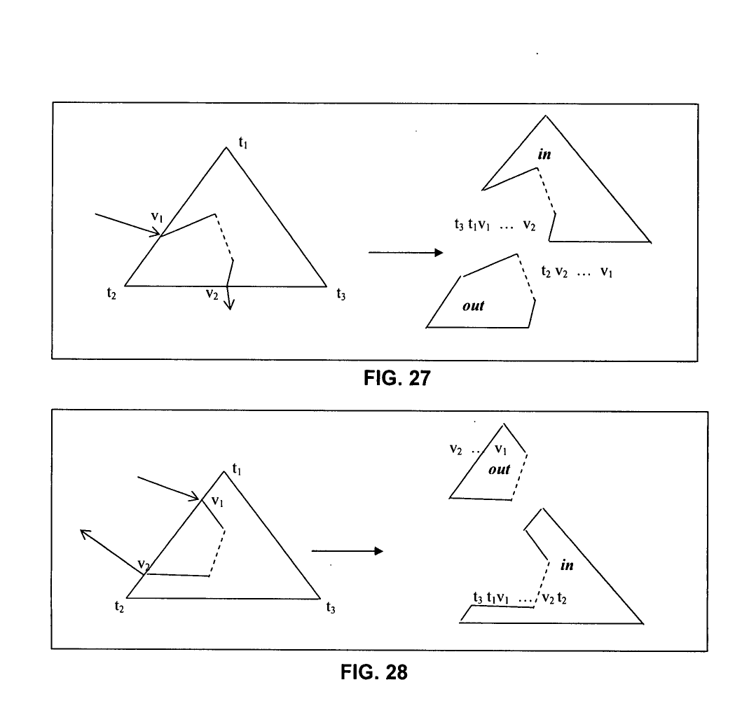

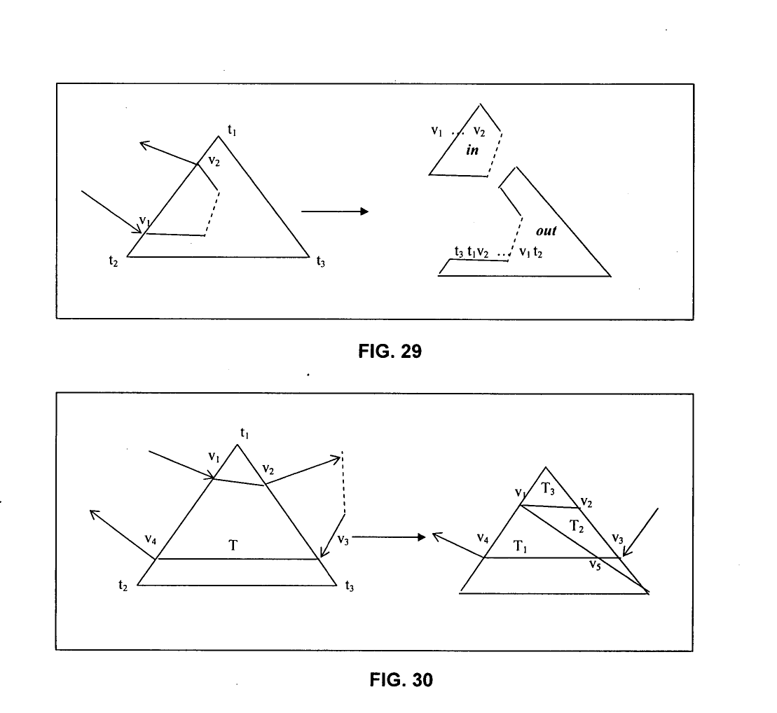

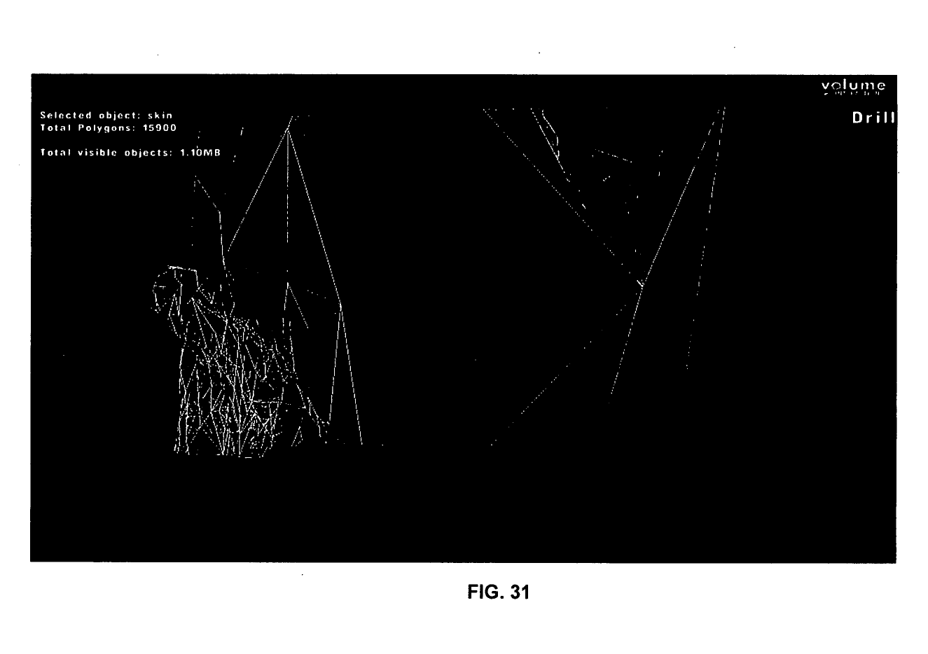

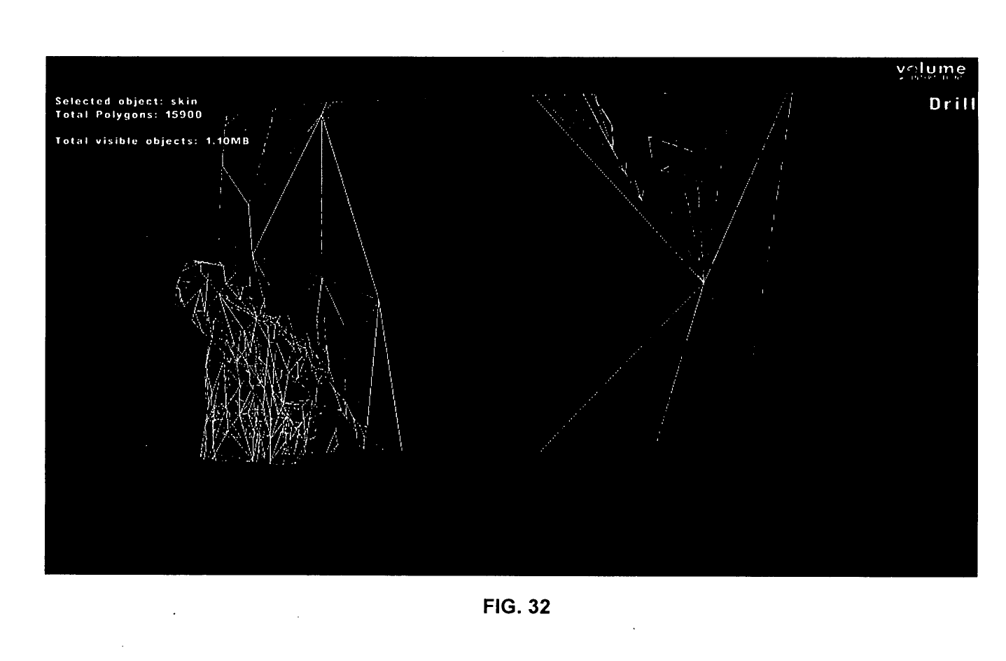

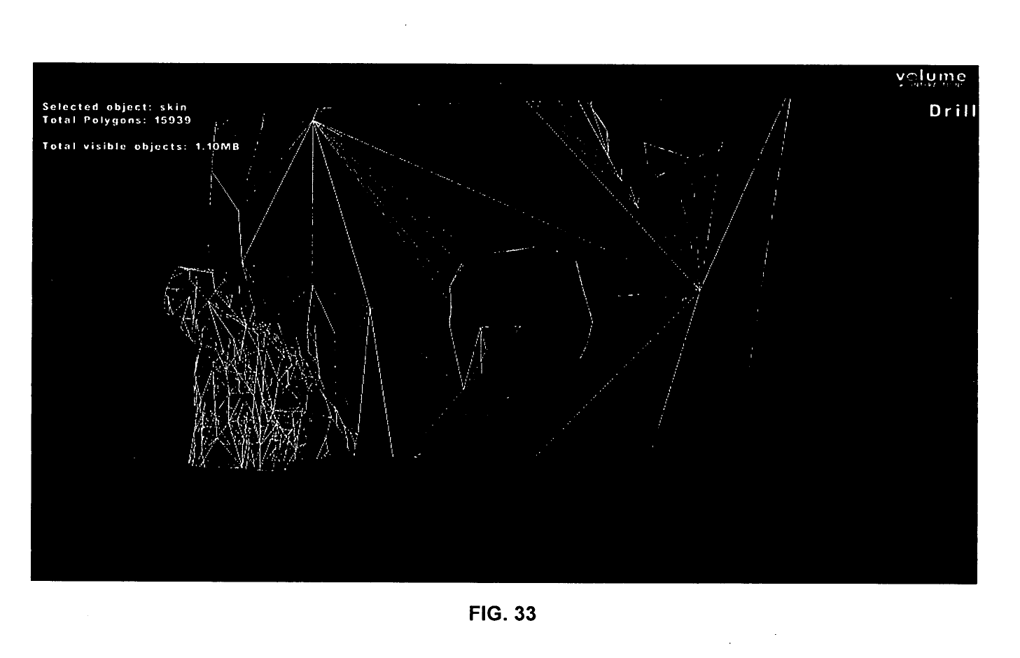

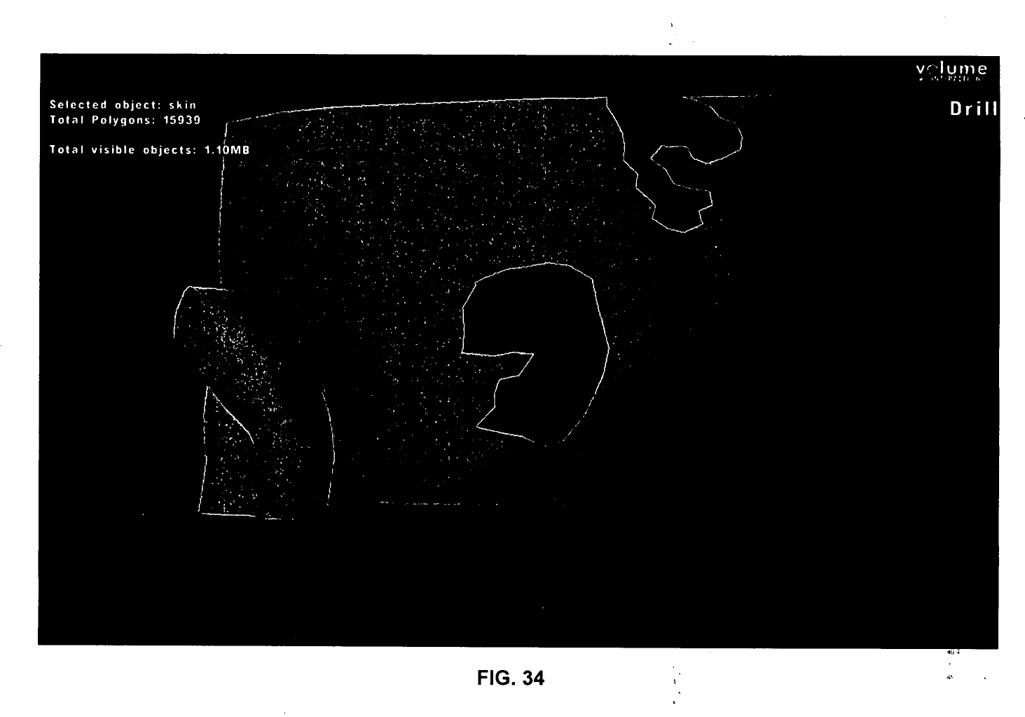

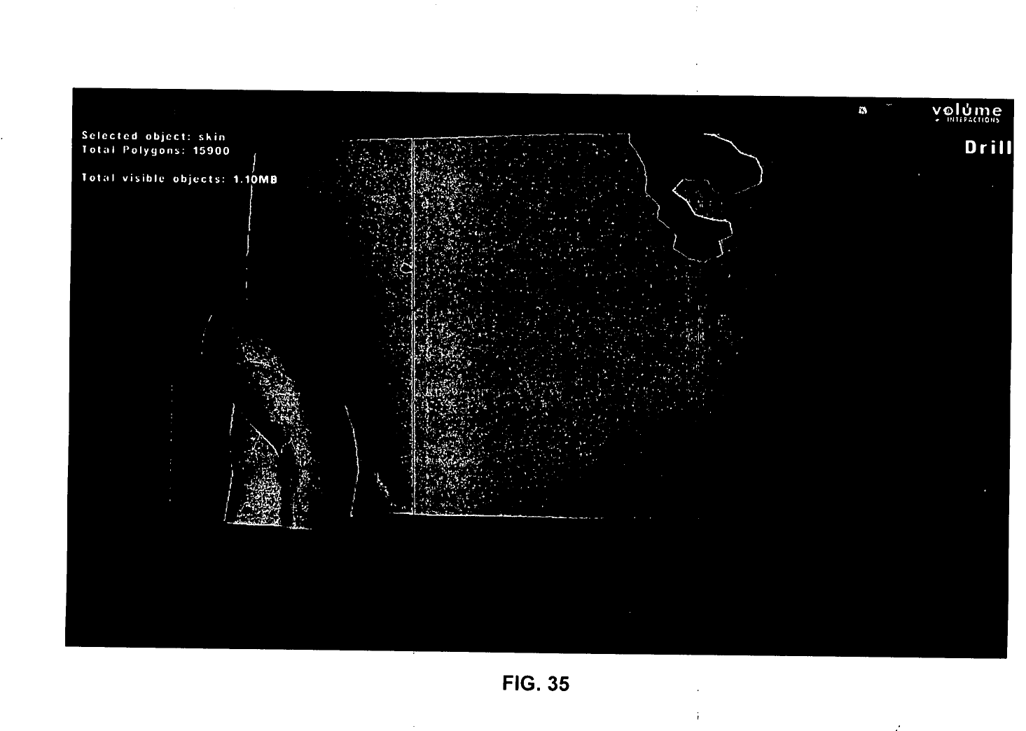

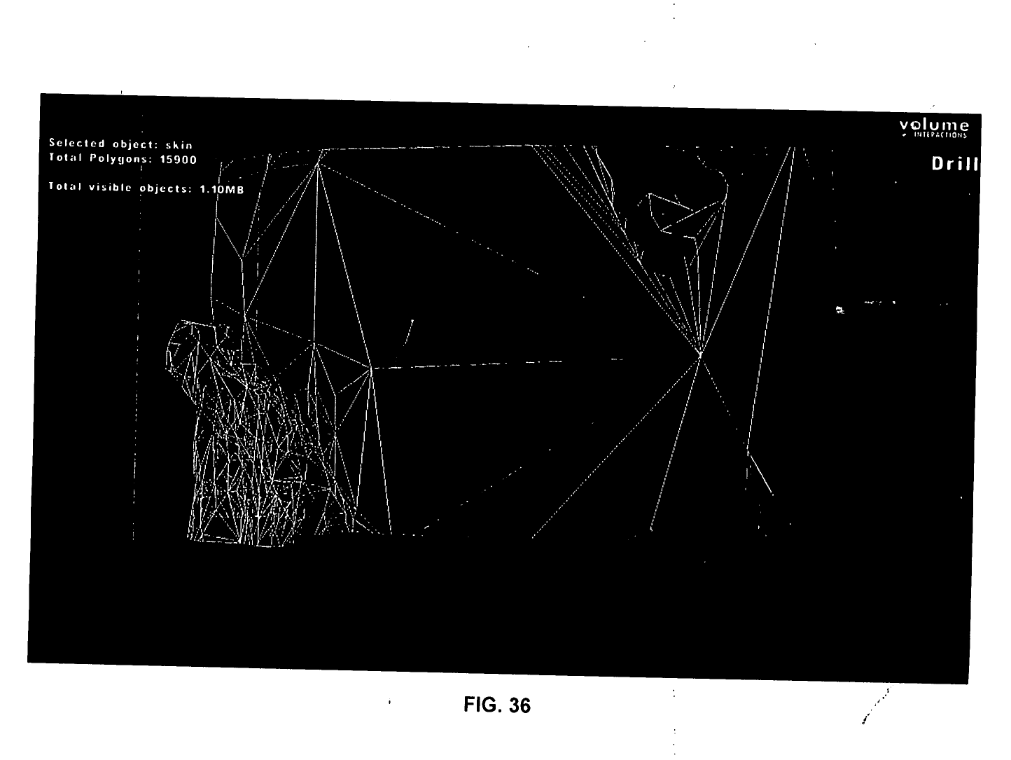

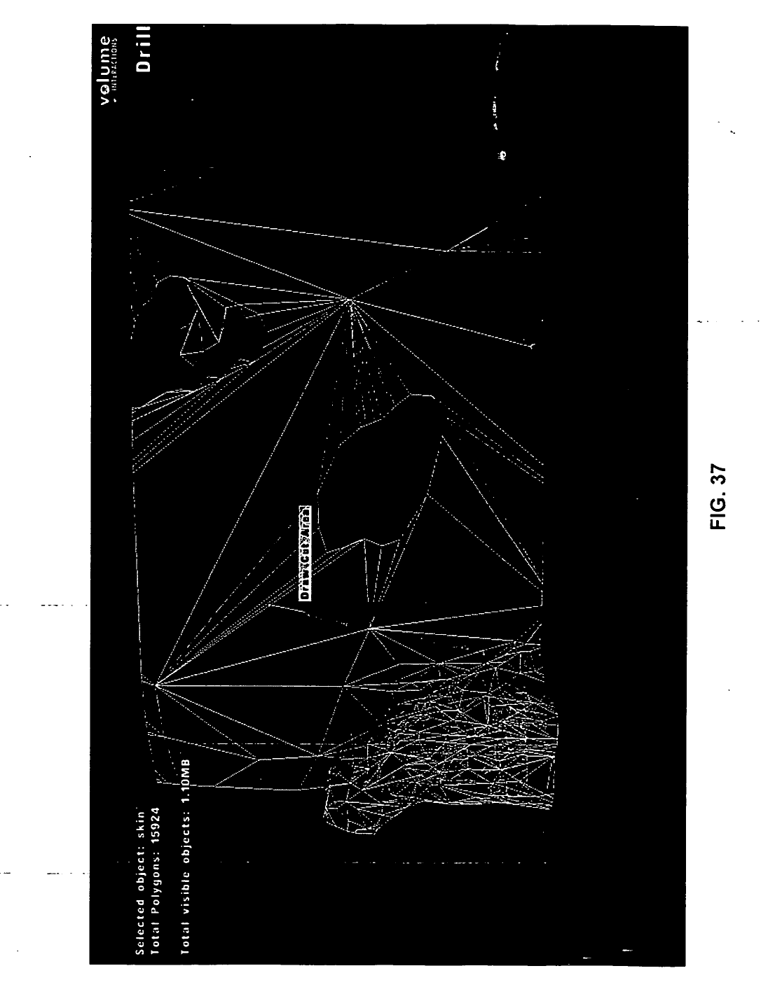

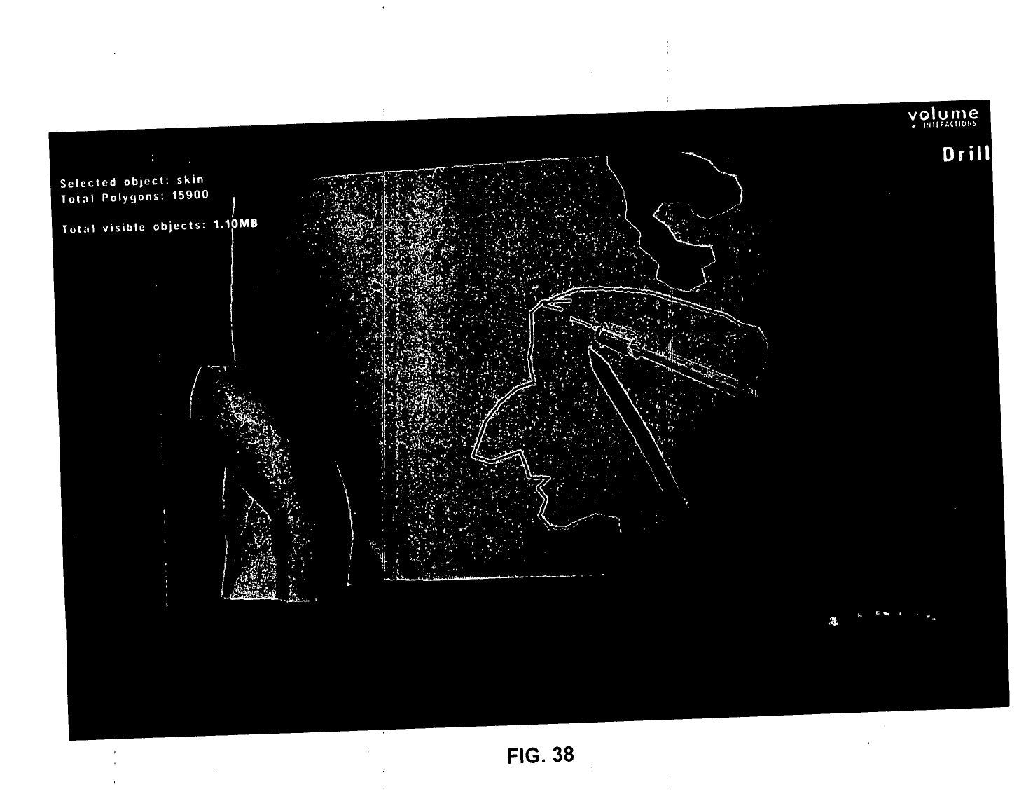

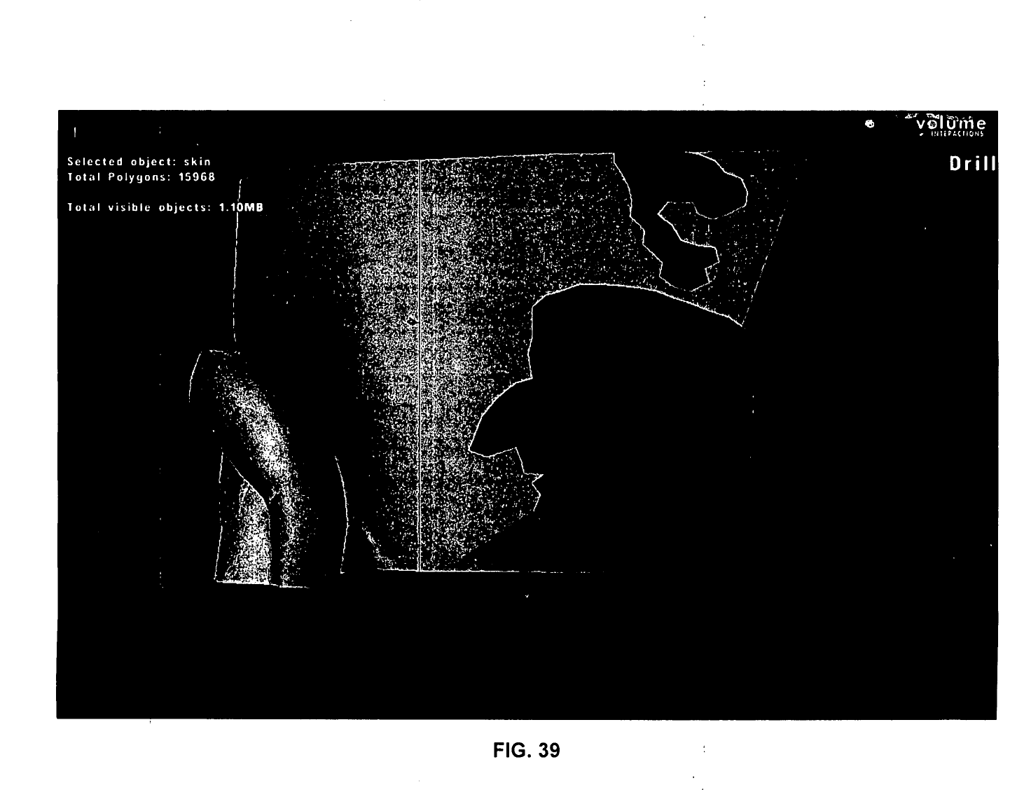

FIG. 9 depicts using the surface point found in FIG. 8(b) as a basis for a next reference point according to an exemplary embodiment of the present invention;

FIG. 10 depicts performing forward scanning from the reference point of FIG. 9 and detection of a next exemplary voxel volume surface point according to an exemplary embodiment of the present invention;

FIG. 11 depicts repeating the process using each surface point obtained as the basis of the next scan according to an exemplary embodiment of the present invention;

FIG. 12 depicts placement of an exemplary starting point on a voxel surface for making a curved measurement according to an exemplary embodiment of the present invention;

FIG. 13 depicts placement of an exemplary end point on a voxel surface for making a curved measurement according to an exemplary embodiment of the present invention;

FIG. 14 depicts generation of an exemplary curved line on an exemplary voxel surface according to an exemplary embodiment of the present invention;

FIG. 14A depicts a top view and side view, respectively, of an intersection test according to an exemplary embodiment of the present invention;

FIGS. 14B-14D illustrate exemplary measurement results obtained using methods according to an exemplary embodiment of the present invention;

FIG. 15 depicts a mesh surface to be cut according to an exemplary embodiment of the present invention;

FIG. 16 depicts the mesh surface of FIG. 15 with the cut area drawn in according to an exemplary embodiment of the present invention;

FIG. 17 depicts the mesh surface of FIG. 15 in wireframe mode with the cut area drawn in according to an exemplary embodiment of the present invention;

FIGS. 18-19 depict the mesh surface of FIGS. 16 and 17, respectively, with the cut area removed according to an exemplary embodiment of the present invention;

FIGS. 20-23 illustrate the cutting process of FIGS. 15-19 using a more complex region according to an exemplary embodiment of the present invention;

FIGS. 24-25 depict extending an existing hole and completing the cut thereby according to an exemplary embodiment of the present invention;

FIGS. 26-30 depict details of mesh cutting at the level of one triangle according to an exemplary embodiment of the present invention; and

FIGS. 31-39 depict additional examples of mesh cutting in wire frame mesh objects.

It is noted that the patent or application file contains at least one drawing executed in color. Copies of this patent or patent application publication with color drawings will be provided by the U.S. Patent Office upon request and payment of the necessary fees.

It is also noted that some readers may only have available greyscale versions of the drawings. Accordingly, in order to describe the original context as fully as possible, references to colors in the drawings will be provided with additional description to indicate what element or structure is being described.

### DETAILED DESCRIPTION OF THE INVENTION

The present invention allows the user to specify any two points in the surface of an object directly in the 3D domain, and then obtain the measurement line connecting the start point to the end point. The user is able to manipulate interactively both the start point and the end point in real time, allowing easy positioning of the points for measurement. The surface line connecting the start point and the end point can also be generated in real time, with its length displayed, allowing the user to visualize the line measurements and make required adjustments.

Two common representations of medical objects are a triangle mesh surface and a voxel volume object. The present invention provides techniques for the generation of surface lines for both mesh objects and voxel volume objects. In exemplary embodiments of the present invention distance on a curved surface can be measured using only two points specified by a user. In exemplary embodiments of the present invention a user can also interactively place such points and visualize the surface line in real time, as well as have the ability to erase points once placed and begin again.

A. Implementation of Triangle Mesh Surface Line Generation

1. Preprocessing the Triangle Mesh Data Structure

To allow the measurement of the surface lines between the points of a mesh object, a user must first be able to place points on the surface of the mesh object. This requires performing an intersection test between the line represented by the user's tool's direction and the triangle surface of the mesh. To facilitate real time specification of the surface points, it is essential to implement an efficient algorithm that can allow fast computation of the intersection point on the triangle mesh. The intersection of a line with a single triangle can be computed based on the following exemplary function as implemented in the following exemplary pseudocode:

Function name : CheckForIntersectionWithTriangle

```
Input:
    line - the start point and end point of a line that will intersect the triangle.
    ptA, ptB, ptC - 3 points of a triangle in which intersection test is performed.
Output:
    flag - to indicate if an intersection is found. True indicates that an intersection of the line with
    the specified triangle has occurred.
    intersectPt - the intersection point if an intersection with the triangle has occurred.
CheckForIntersectionWithTriangle ( )
    Compute the vector from ptA to ptB
    Compute the vector from ptA to ptC
    Compute the triangle normal vector by computing the cross product of the above 2 vectors
    Normalize the normal vector
    Equation of the plane of the triangle is represented at Ax + By + Cz + D = 0
    D can be compute as parameter Ax, By, Cz are components of the normal vector
    An intersection with the plane is found by solving the line equation with the plane equation
    Let the intersection point be term as ptD
    If intersection found then
        Compute vector A as the vector from ptA to ptD
        Compute vector B as the vector from ptB to ptD
        Compute vector C as the vector from ptC to ptD
        Given the 3 vectors, angle ADB, angle BDC and angle CDA can be computed
        If sum of 3 angles is equal to 360 degrees then
            Intersection point ptD is inside triangle
            Return true
        Else
            Return false
    Else
        return false
    End function
```

In exemplary embodiments of the present invention a triangle mesh can be represented, for example, as a collection of vertices and triangles. Such a collection of vertices can contain information on the coordinates of the points of the mesh. The collection of triangles can contain information on the vertices that made up the individual triangles of the mesh. Although such a representation is simple and efficient for drawing a mesh object, the random spatial order that such data usually assumes can make it difficult to perform the abovedescribed intersection test. To compute the surface point, an intersection test based on the pseudocode presented above would have to be performed on all triangles in the object. Although the intersection test of a line with a single triangle can be performed quickly, this can be computationally expensive for a mesh with a large number of triangles. Therefore, in exemplary embodiments of the present invention preprocessing can be utilized to restructure an existing data structure into other forms that can facilitate efficient computation of surface points and generation of surface lines.

2. Construction of Grid Data Structure for Triangle Mesh Object

A grid data structure aims to divide a mesh object into various smaller regions. Based on a bounding volume of the mesh object, a mesh object can be divided into smaller blocks. Each triangle in the mesh object can be processed to determine the block that contains the triangle. At the end of this preprocessing step, each block representing part of a triangle mesh boundary can contain a list of triangles that are within the block boundary. To find a surface point, it is first necessary to determine the blocks that intersect with the line. This computation is trivial and can be easily performed. Once the blocks are determined, the surface point can be found, for example, by performing an intersection test on the triangles associated with the block. This can be performed efficiently since each block contains only a small subset of the triangles of the mesh object. Hence using such an exemplary data structure can eliminate the need to check all triangles of the mesh in order to find the surface point, resulting in a faster and more efficient computation.

3. Representing the Relationship of Triangles and Vertices

The purpose of this exemplary preprocessing step is to create, for example, a data structure that can provide fast access to the neighboring vertices of a vertex. Each triangle in a mesh is made up of three vertices. For each vertex, the other two vertices in its triangle will be its neighbors. Triangles with common vertices indicate that the triangles are directly connected to each other. By processing each triangle in a mesh object, a list of vertices and their direct connected vertices can be obtained. Similarly, a list of vertices and their direct connected triangles can, for example, be obtained. This structure is essential in the efficient generation of a surface line as well as improving the performance in the computing of surface points on the mesh.

4. Determining the Boundary Edges and Vertices

The purpose of this preprocessing step is to create a data structure that maintains the list of vertices that specify the boundary of the mesh object. Each triangle in the mesh is made up of 3 edges. A particular edge of a triangle may also be the edge of other triangles in the mesh. In this case, the edge is a shared edge. Therefore edges that are not shared will be the boundary edges of the mesh object. By using the results from the above constructed data structure, it is easy to determine the boundary edges of the mesh object. As each edge is connected to another edge on the boundaries of the mesh object, it is possible to trace the edges that define a particular boundary of the mesh object. At the end of this preprocessing, the boundaries of the mesh object and the vertices associated with each boundary can be obtained. This information is required in the generation of a surface line in which the line crosses the boundary of the mesh object. The process flow of an exemplary preprocessing stage is shown in the pseudocode provided below. Thus, in exemplary embodiments of the present invention, the following pseudocode can, for example, be used to implement a preprocessing stage for surface point computation as described above.

Exemplary Pseudo Code for Preprocessing Stage

```
Function name : GenerateGridStructureForMesh
Input:
    Mesh object data structure consisting of:
        An array representing the vertices of each triangle
        An array representing the coordinates of each vertex
Output:
    A grid structure consisting of:
        An array of blocks that form the bounding box of the mesh object
        An list of triangles that are associated with each of the blocks
GenerateGridStructureForMesh ( )
    Compute the minimum X, Y, Z values by checking through the coordinates of all vertices of
    the mesh object
    Compute the maximum X, Y, Z values by checking through the coordinates of all vertices of
    the mesh object
    StepX = (maximumX − minimumX) / number of blocks along x - axis
    StepY = (maximumY − minimumY) / number of blocks along y - axis
    StepZ = (maximumZ − minimumZ) / number of blocks along z - axis
    For each triangle in the mesh object
        Get the vertices of the triangle
        Get the coordinates of the triangle
        Get min X, Y, Z values by checking the coordinates of the 3 vertices of the triangle
        Get max X, Y, Z values by checking the coordinates of the 3 vertices of the triangle
        Compute the blocks that will contain the triangle using the following
        StartX = (minX − minimumX) / StepX
        EndX = (maxX − minimumX) StepX
        StartY = (minY − minimumY) / StepY
        EndY = (maxY − minimumY) StepY
        StartZ = (minZ − minimumZ) / StepZ
        EndZ = (maxZ − minimumZ) StepZ
        For x = StartX to EndX
            For y = StartY to EndY
                For z = StartZ to EndZ
                    Add the triangle to the list associate with the block index by
                    (x, y, z)
                Next
            Next
        Next
    Next
End function
```

Function name : ConstructVertexLinkStructure

```
Input:
    Mesh object data structure consisting of:
        An array representing the vertices of each triangle
        An array representing the coordinates of each vertex
Output:
    An array of connecting triangles. Each element of the array is a list of triangles connected to
    the reference vertex
    An array of neighboring vertices. Each element of the array is a list of neighboring vertices
    connected to the reference vertex and whether the edges formed by the vertices to the
    reference vertex are shared
ConstructVertexLinkStructure ( )
    For each triangle in the mesh object
        Set the current reference vertex as the first vertex of the triangle
        The neighbor vertices of this vertex will be the second and third vertex of the triangle
        Add the neighboring vertices to the list associated with the current reference vertex
        If the neighboring vertices are already in the list
            This indicate that the edges for by the reference vertex and the neighboring
            vertices are shared with other triangles. Set shared edge to true.
        End if
        Add the current triangle to the list of connected triangles associated with the current
        reference vertex
        Set the current reference vertex as the second vertex of the triangle
        The neighbor vertices of this vertex will be the first and third vertex of the triangle
        Add the neighboring vertices to the list associated with the current reference vertex
        If the neighboring vertices are already in the list
            This indicate that the edges for by the reference vertex and the neighboring
            vertices are shared with other triangles. Set shared edge to true.
        End if
        Add the current triangle to the list of connected triangles associated with the current
        reference vertex
        Set the current reference vertex as the third vertex of the triangle
        The neighbor vertices of this vertex will be the first and second vertex of the triangle
        Add the neighboring vertices to the list associated with the current reference vertex
        If the neighboring vertices are already in the list
            This indicate that the edges for by the reference vertex and the neighboring
            vertices are shared with other triangles. Set shared edge to true.
        End if
        Add the current triangle to the list of connected triangles associated with the current
        reference vertex
    Next
End function
```

```
Function name : ConstructBoundaryStructure
Input:
    Mesh object data structure consisting of:
        An array representing the vertices of each triangle
        An array representing the coordinates of each vertex
Output:
    An array of lists of boundaries with each list representing a collection of vertices that specified
    the boundary of the holes on the mesh object
ConstructBoundaryStructure ( )
    For each vertices in the mesh object
        If vertex has been processed then
            Get the next vertex in the mesh object
        Get the list of neighboring vertices connected to the vertex
        For each connecting vertices to the current vertex
            If edge form by connected vertex to the current vertex is not shared
                This indicates that the connected vertex lies on the boundary of hole
                Loop
                    Assign the connected vertex as the current vertex
                    Mark this vertex as been processed
                    Add this vertex to list that represent the boundaries of the
                    hole
                    Check for connected vertices of the current vertex for the next
                    connected vertex that lies on the boundary of the hole
                    If no more boundary vertices are found, exit loop
                End loop
            End if
        Next
    Next
End function
Function name : PerformSetup
Input:
    Mesh object data structure consisting of:
        An array representing the vertices of each triangle
        An array representing the coordinates of each vertex
PerformSetup ( )
    GenerateGridStructureForMesh ( )
    ConstructVertexLinkStructure ( )
    ConstructBoundaryStructure ( )
End function
```

5. Computing the Surface Point

In exemplary embodiments of the present invention, for generation of a surface line, users need to be able to specify the start point and end point on the surface of a mesh object. As noted above, a surface point can be determined as the intersection of a ray (formed by the direction of the virtual tool) with the mesh object surface. A fast intersection test can be performed to check for intersection with any of the blocks in the grid data structure. Once blocks of interest are obtained, an intersection test can be performed on the blocks' associated triangles to determine the actual surface point on the mesh object. As the number of associated triangles is significantly less than the total number of triangles in the mesh object, this method is efficient and lets the user update the surface point in real time.

To further improve the efficiency in computing the surface point, a heuristic approach can be implemented and integrated into the above process. It can be observed that once a user specifies an initial surface point on the mesh object, subsequent adjustments to the surface point results in a new point that is quite close to the previous point. Utilizing this observation, in exemplary embodiments of the present invention once an initial triangle surface is obtained, subsequent intersection tests can be limited to the neighboring triangles of the initial triangle. This results in very fast computation, as the number of neighboring triangles is usually very small. Due to the earlier preprocessing stage described above, it can be fast and easy to obtain the neighboring triangles. This combined approach can, for example, result in fast and efficient computation of surface points as is required to define the start point and end point of an exemplary surface measurement. Exemplary pseudocode for computing a surface point is next described below. Thus, in exemplary embodiments of the present invention, the following pseudocode can, for example, be used to implement surface point computation.

Exemplary Pseudocode for Computing the Surface Point

```
Function name : GetMeshIntersection
Input:
    A ray represented by the tool direction
    A previous intersected triangle index
Output:
    flag - to indicate if an intersection is found. True indicates that an intersection of the ray with
    the mesh object has occurred.
    intersectPt - the intersection point if an intersection with the mesh object has occurred
    triangleIndex - indicate the triangle surface in which the intersection has occurred
GetMeshIntersection ( )
    If there is previous intersected triangle index
        If CheckForIntersectionWithTriangle ( ) is true
            Return true
        End if
    End if
    If ray intersects bounding box of the mesh object
        For each point along ray path starting from the bounding box intersection point
            If point is inside bounding box of mesh object
                Retrieve list of triangles associated with each sub block in the mesh
                object
                For each triangle in the list
                    If CheckForIntersectionWithTriangle ( ) is true
                        Return intersect point and intersected triangle index
                        Return true
                    End if
                Next
            Else
                Return false
            End if
        Next
    Else
        Return false
    End if
End function
```

When a user activates an exemplary virtual tool a PerformSetup ( ) function can be called to run all the required preprocessing functions. When the user moves the exemplary virtual tool GetMeshintersection ( ) function can be continuously called to obtain the current surface point on the mesh object.

6. Generating the Surface Line

When a user specifies both a start point and an end point on a mesh surface, a line can be drawn connecting both points and a measurement of the length of the line can be shown. The main challenge in generating such a line is the numerous ways and directions in which a line can be generated to connect the start point to the end point. A main criterion for selecting a way to connect such points is that the line generated should be intuitive to the user. In exemplary embodiments of the present invention an approach to select such a line can, for example, be to define a plane such that it contains both the start and end point. The intersection of the plane with the mesh object can thus define the line that connects the start point to the end point. Using the start point and end point is not sufficient to define the plane, however. Thus, in exemplary embodiments of the present invention a user's eye position can be used as a third point to define such a plane. This will result, for example, in a line that is orthogonal to the user's eye position, which is natural and intuitive to a user. Thus, in exemplary embodiments of the present invention, the eye position can be set to be approximately 40 cm away from the origin of the 3D environment along the z-axis, away from the screen.

With a plane so defined, the next important step is to define the direction of approach. A plane will intersect a triangle's surface at two points on the edges of the triangle (i.e., where, as in a mesh, there are only triangles—edges and vertices—but nothing inside them).

Therefore at the triangle surface of the starting point, the plane intersection will result in two possible directions of approach of the line from the start point to the end point. To decide which intersection point to use, the point that is deemed to correspond more with the direction from the start point to the end point can, for example, be used. To make this determination a vector indicating the direction from start point to end point can, for example, be computed. The start point and end point can be represented as 3D coordinates x0, y0, z0 and x1, y1, z1 respectively. Such a direction vector can thus be computed, for example, as (x1-x0, y1-y0, z1-z0). For each of the intersection points, a plane containing the intersection point perpendicular to the direction can be derived. An intersection test can be, for example, performed on the plane with the line segment formed by start point and end point. The point whose plane results in an intersection can be set as the selected point of approach, as is illustrated in both top view and side view, respectively, in FIG. 14A. In the situation where both points do not result in an intersection (such as, for example, where a plane is formed that lies on the start point of the line segment), then the point which is nearest to the end point can be selected as the point of approach.

In exemplary embodiments of the present invention, the following pseudocode can, for example, be used to implement the determination of the point of approach.

Exemplary Pseudo Code for Determination of Point of Approach

```
Function name : GetPointOfApproach
Input:
    StartPt: the start point of the line node
    EndPt: the end point of the line node
    IntersectA: first possible point of approach
    IntersectB: second possible point of approach
Output:
    ApproachPt: the approach point choosen
GetPointOfApproach ( )
    Compute vector of approach from StartPt to EndPt
    Define the line segment represented by StartPt and EndPt
    The following equation Ax + By + Cz + D = 0 is used to represent the plane
    The components A, B, C are given by the vector of approach
    By using the x, y, z position of IntersectA or IntersectB, the perpendicular plane form by these
    2 points along the vector of approach, can be computed
    The 2 plane form are defined as planeA and planeB
    If planeA intersects the line segment
        IntersectA is used as the point of approach
        Return
    End if
    If planeB intersects the line segment
        IntersectB is used as the point of approach
        Return
    End if
    If planeA and planeB does not intersect line segment or both plane intersect line segment then
        Compute the distance distA from IntersectA to EndPt
        Compute the distance distB from IntersectB to EndPt
        If distA is smaller the distB then
            IntersectA is used as the point of approach
            Return
        Else
            IntersectB is used as the point of approach
            Return
        End if
    End if
End function
```

With the start point and the approach point (also termed as the link point) defined, the next step is to find, for example, the next link point on the surface and iteratively progress until the end point is reached. Based on the triangle surface of the approach point, it is easy to access its neighboring triangles using the preprocessed data structure described above. An intersection test with the plane can be performed on each of the neighboring triangles. Triangles that have an intersection with the plane will have two intersection points. If one of the intersection points is the link point, the other intersection point will be the connecting point of the line. The link point can then be updated to this new connecting point. By repeating the above steps, the points of the surface line can obtained. The iteration can be terminated once a point having the same triangle surface with the end point is obtained (implying that the line has reached the end point).

In the process of computing the next link point; it is possible that a direct connected link point cannot be found (such as, for example, if the current link point has reached the boundary of the mesh object). In such a situation, it is essential to find the next suitable link point on the boundary and continue the approach to the end point. When the link point has reached a boundary, it is easy to access information on the edges that define the boundary using the data structure created in the preprocessing stage. By finding the next edge on the boundary that intersects with the defined plane, the next link point across the boundary can, for example, be determined and the line can continue its approach to the end point.

By summing the distance between each point along the generated surface line, the total distance of the surface line from start point and end point can, for example, be obtained.

7. Screenshots Depicting Generation of Surface Lines and Measurements on Mesh Object Surface

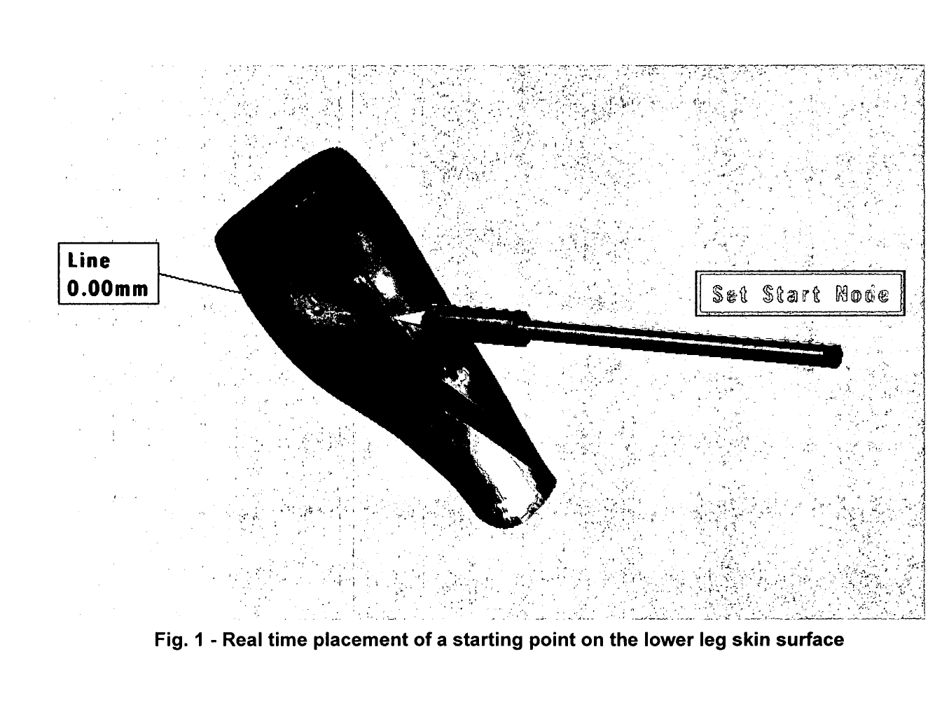

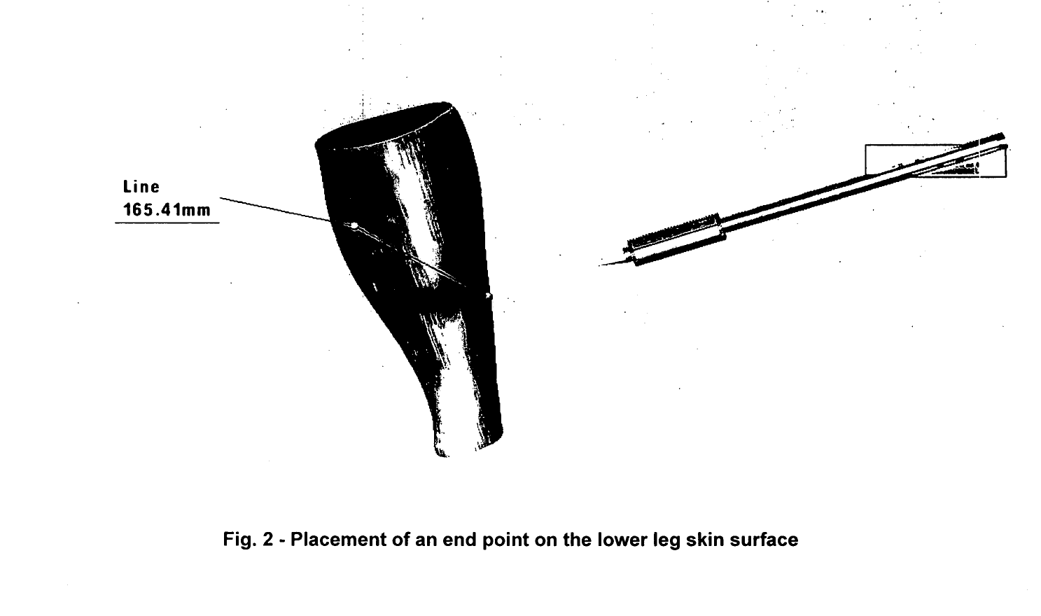

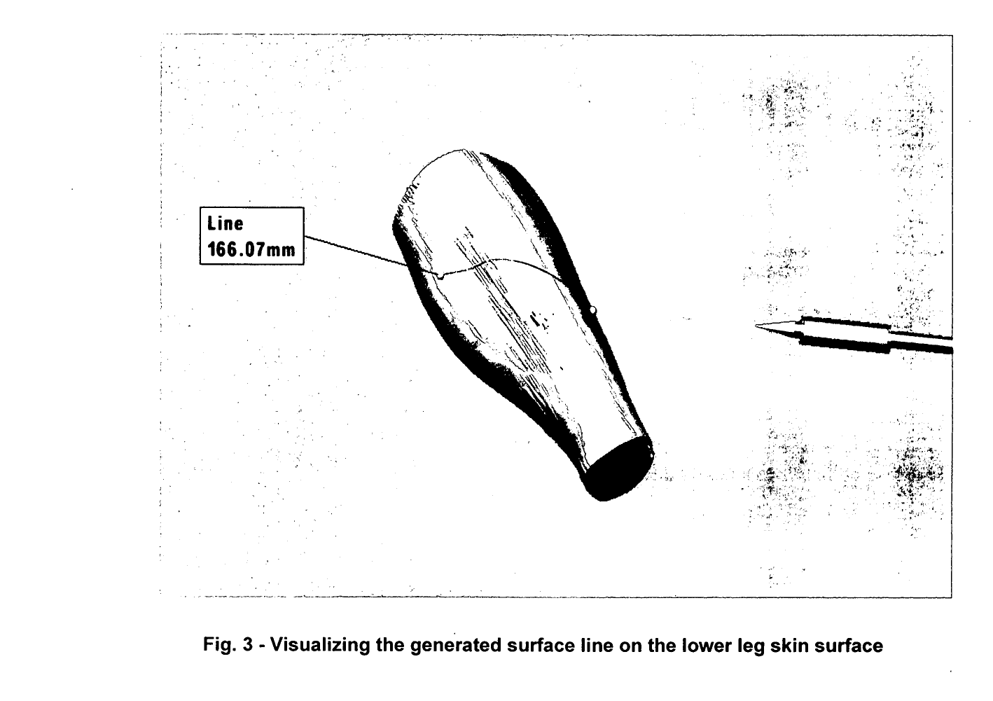

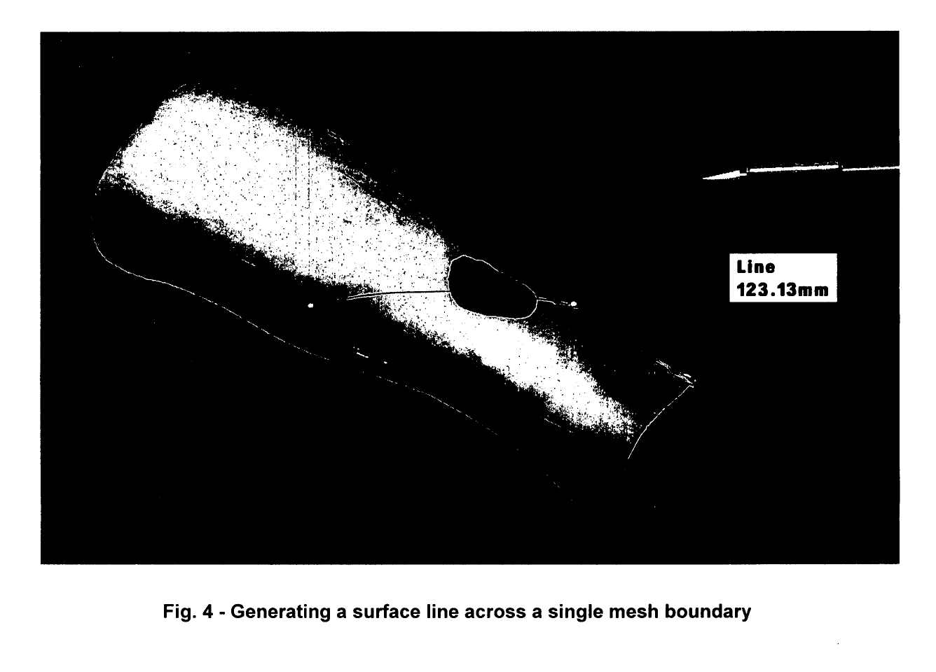

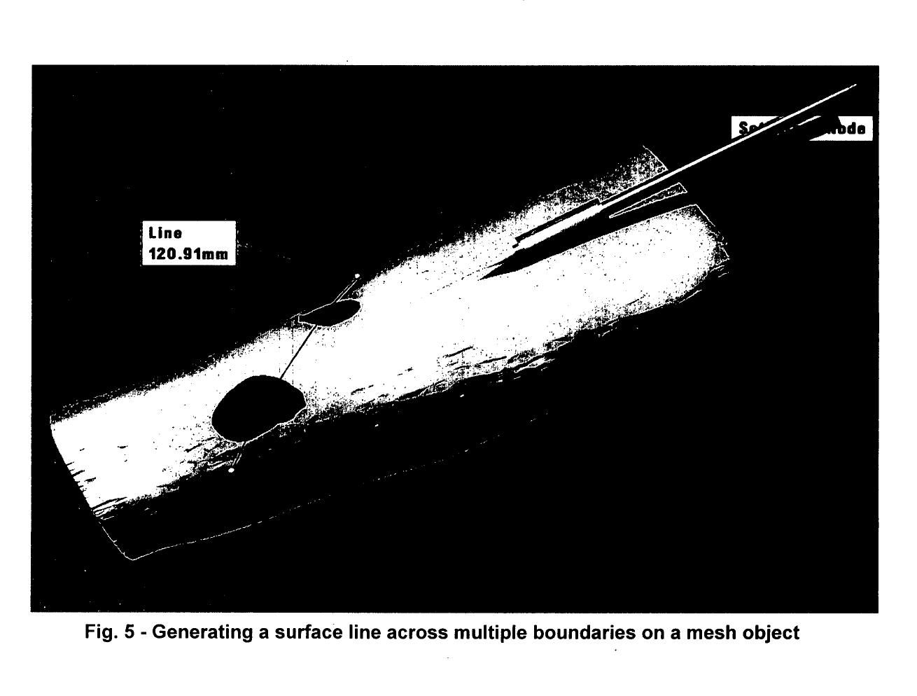

FIGS. 1-5 illustrate the generation of a line on a curved surface in exemplary embodiments of the present invention. With reference thereto, FIG. 1 depicts the placement of an exemplary starting point on a leg mesh object, and FIG. 2 depicts the placement of an exemplary end point on that object. The line connecting the two points (not restricted to be along the surface) is shown. FIG. 3 depicts the generation of an exemplary curved line on the leg object's surface, and its slightly greater length than that shown in FIG. 2. FIG. 4 depicts the generation of an exemplary curved line across a mesh boundary on the surface, and FIG. 5 depicts generation of an exemplary curved line across multiple mesh boundaries on the surface.

B. Use of Line Generation On Curved Surface For Mesh Cutting

The exemplary methods described above specify how a line on a curved surface can be generated from point to point. This method can be extended to include the generation of a line on a surface for a series of points. This can be done by grouping the series of points into pairs and using the above implementation to generate a surface line between each set of pairs. By generating a surface line from the last point in the series of points to the first point in the series, a closed region with lines on the mesh surface object can be defined. This can be used to define a region on the mesh surface and subsequently the perimeter of such a region can be measured. The region specified can also be further processed to remove the surface from the mesh object.

FIGS. 15-25 illustrate this method vis-á-vis two exemplary regions being cut out of a mesh surface according to exemplary embodiments of the present invention. In exemplary embodiments of the present invention, a mesh surface is composed of triangles. The details of how an existing triangle is cut when the region runs across it are illustrated in FIGS. 26-30, as next described. FIGS. 31-39 illustrate additional examples of mesh cutting.

As described above, it is often necessary to divide a surface object into two parts according to some user defined closed curves—the curve should be closed or closed related to the boundary. For example, cutting a surface object and making the inside visible. The surface object can be represented by a 3D triangle mesh. The curve used to cut the surface object can be defined by a 3D polygon—every point of an edge of the polygon must be located on the surface.

It is assumed that every triangle in the triangle mesh is counter-clockwise. When a 3D polygon P cuts a triangle mesh, every point of an edge of P must be located on the surface. To cut the triangle mesh, it is necessary to find those triangles cut by P, and divide the triangle into two parts: one being within the area defined by P (marked as in), and the other being out of the area defined by P (marked as out). There is no directional requirement (counter-clockwise or clockwise) for how the polygon is constructed.

For a triangle T cut by P, at least two vertexes of P must locate on one or more than one edges of T. The problem can be simplified as an edge strip s of P cutting the correspond triangle T: the two ending vertexes (entering vertex v₁ and leaving vertex v₂) of s must be located on one or two edges of T and all other vertexes of s must be within T. According to such a simplification, the 3D cutting can be simplified as a 2D cutting—as shown in FIG. 26, for example, v₁ is the point where P entered T and v₂ is the point where P left T.

When a triangle is cut by an edge strip, the triangle is always divided into two polygons. Depending on how s enters and leaves T, the construction of the two polygons can be, in exemplary embodiments of the present invention, different. FIGS. 26-30 show examples of how to construct the two polygons. To cut a triangle by an edge strip, assuming the entering vertex located on edge t₁t₂, there are several cases.

There are many ways to triangulate a 2D polygon. For a 2D polygon, one way is to find an interior diagonal (no intersection with any edge of the polygon) and divide the 2D polygon into two polygons. For the two polygons, the above process can be applied, for example. The process can be continued unless the input polygon has only three vertexes.

Sometimes, for example, a Tcan be cut by P more than once. FIG. 30 shows an example of a triangle cut by two edge strips. When processing edge strip v₁v₂, Twill be divided into three triangles T₁, T₂, T₃. It is thus necessary to update information for edge strip v₃v₄:
1) Whether there is new intersecting point. If yes, inset it into P. In FIG. 30, there is one intersecting point v₅, which should be insert into P. The original edge strip v₃v₄ will become two edge strip v₃v₅ and v₅v₄.
2) Additionally, the triangle index cut by the edge strip should be updated. For example, the triangle cut by the edge strip v₃v₅ should be T₂ and the triangle cut by the edge strip v₅v₄ should be T₁.

As described above, in exemplary embodiments of the present invention a surface object can be divided into two parts: one marked as in—within the area defined by P, and the other marked as out—out of the area defined by P. In FIGS. 26-29, for example, for every polygon marked as in, all the triangles triangulating that polygon are marked as in. Thus, for every polygon marked as out, all the triangles triangulating that polygon are marked as out. After all edge strips have been processed, the following computation can be performed:

1) For every in (out) triangle, except for its vertices belonging to P, its other vertices are marked as in (out);
2) If a vertex of a triangle is marked as in (out), then the triangle should be marked as in (out).

In exemplary embodiments of the present invention the above process can be iterated until all triangles are marked as either in or out.

According to the abovedescribed algorithm, a surface object (triangle mesh) can thus be divided into two parts. The results of this division can be used for a wide variety of applications. According to the requirements of a given application, it is often convenient to only show one part (in or out) according to some user defined criteria (for example, the size of area, the number of triangles, etc.) It also can be used to construct two new objects.

Further Examples of Mesh Cutting

FIGS. 31-39 depict three additional examples of mesh cutting according to exemplary embodiments of the present invention, as next described.

1. FIGS. 31-34 illustrate a first example. FIG. 31 depicts the wire frame of a triangle mesh object. This mesh object is the candidate to be cut. FIG. 32 depicts a curve (red in color version, grayish in greyscale version) which has been drawn on the surface of the mesh object. FIG. 33 shows the result after the mesh object has been cut by the curve shown in FIG. 32. FIG. 34 shows the same result as is shown in FIG. 33, except that the mesh object is here drawn in solid mode. Here the outline of the cutting curve can easily be seen.

2. FIGS. 35-37 illustrate a second example. FIG. 35 depicts a triangle mesh object (essentially the same object as is depicted in FIG. 31) in solid mode. This mesh object is the candidate to be cut. FIG. 36 depicts a cutting curve (red in color version, grayish in greyscale version), which has been drawn on the surface of the mesh object, now shown in wire frame mode. FIG. 37 depicts the result after the mesh object has been cut by the curve shown in FIG. 36, shown in wire frame mode.

3. FIGS. 38-39 illustrate a third example. FIG. 38 depicts a curve (red in color version, white in greyscale) which has been drawn on the surface of a mesh object shown in solid mode. Once again the mesh object is the same as that depicted in FIG. 35 in solid mode and in FIG. 31 in wire frame mode. FIG. 39 depicts the result after the mesh object has been cut by the curve shown in FIG. 38.

Exemplary Data Structures and Pseudocode for Mesh Cutting

The following exemplary data structures for mesh objects can be used in an exemplary mesh cutting implementation according to exemplary embodiments of the present invention. These structures can, for example, keep track of neighbor vertex and triangle information.

For every vertex A of a mesh to be cut, define a structure as follows:

| | |
|---|---|
| Pointer* | A pointer to its coordinates |
| List | Stores its neighbor vertex. Vertex B is a neighbor of Vertex A |
| | if and only if both of them are vertexes of a triangle. |
| List | Stores the neighbor triangles. A triangle is a neighbor of |
| | Vertex A if and only if Vertex A is a vertex of it. |
| Marker | To indicated whether the vertex is removed or not, and |
| | whether it is a boundary vertex or not. |

For every triangle TA of a mesh to be cut, define a structure as follows:

| | |
|---|---|
| Pointer[3] | A pointer array, store three pointers to its vertex structure |
| Normal | The triangle normal |
| Marker | To indicated whether the triangle is removed or not |

In exemplary embodiments of the present invention, the following pseudocode can, for example, be used to implement mesh cutting.

Pseudocode for mesh cutting

```
Input:
    Triangle mesh M.
    Polygon P on M
Output:
    Triangle Mesh Mcut
Cut Mesh( )
        Search for unprocessed edge strip v1v2 in P, as shown in Figs.
        27, 28 and 29;
        If all edge strips have been processed, then return the result
        triangles except those marked as “in” and “removed”;
        Mark the corresponding triangle as “removed”;
        Divide the corresponding triangle into two parts P1 and P2,
        P1 should be within P, and P2 should be outside of P;
        Triangulate polygon P1, and mark all new generated triangle
        from this triangulation as “in”;
        Triangulate polygon P2, and mark all new generated triangle
        from this triangulation as “out”;
        Check whether the unprocessed edges in P intersect with the new
        generated triangles from the triangulation of P1 and P2,
        If yes, update the polygon P on P.
```

C. Implementation of Volume Object Surface Line Generation
1. Computing A Surface Point

For the generation of a surface line, users need to be able to specify the start point and end point on the surface of the volume object. In exemplary embodiments of the present invention a surface point can be determined as the intersection of a ray (formed by the direction of a virtual tool) with the volume object surface. A volume object is made up of voxels whose values indicate the transparency of the voxels. Voxels with values above a particular threshold represent the structure of the object (i.e., are “inside” voxels) while values below the threshold indicate that it is not part of the object structure (i.e., an “outside” voxel).

Finding a surface point on a volume object requires finding a point along the ray of the virtual tool in which there is a transition of a voxel value below the threshold value to a voxel above the threshold value is detected. Starting from the tip of the virtual tool, the voxel value is retrieved. If the value is above the threshold defined, this indicates the tool tip is inside the volume object hence no surface point is computed. A value below the threshold indicates that the tool tip is not inside the volume object and a surface point maybe found. By incrementally moving along the ray defined by the tool tip towards the volume object, the surface point can be obtained once a voxel with value above the threshold is found.

2. Generating a Surface Line

When a user specifies both a start point and an end point on a volume object's surface, a line is drawn connecting both points and the measurement of the length of the line is shown. The main challenge in generating such line are the numerous ways and directions in which a line can be generated to connect the line from start point to the end point. The main criterion for selecting the way to connect the points is that the line generated should be intuitive to the user. The approach to select the line can be to first define a plane such that it contains both the start point and the end point. The intersection of the plane with the volume object can define the line that connects the start point to the end point. However, using only the start point and end point is not sufficient to define a plane. A user's eye position, for example, can thus be used as a third point to define the plane. This can, for example, result in a line that directly faces a user at his eye position, which is more natural and intuitive to a user.

Unlike a mesh object with well-defined connected vertices and triangles defining the surface object, a volume object is defined solely by the voxel intensity values. Therefore, the transition of intensity value can be used as the indicator of the surface of the volume object. In exemplary embodiments of the present invention a scanning technique using a circular region can be implemented to generate a surface line from the start point to the end point. At each point of the line, a scan of a predefined radius range can be performed to determine the next link point. The process can be repeated until it reaches the end point or until a predefined number of iterations has been performed.

The above described process can be illustrated, for example, as shown in FIGS. 6-14. In exemplary embodiments of the present invention it can include the following processes:

a. To perform a radical scanning, an initial reference point with respect to the start point is required. Based on the start point and the direction of the vector from start point to end point, a point having a small displacement away from the start point can be defined as a reference point. This is shown in FIG. 6 where an initial reference point 610 (yellow) is shown along the line drawn through start point 620 and end point 640, both of which are colored red and lie on volume object surface 630. The initial reference point 610 is in a direction away from start point 620.

b. The reference point can then be rotated along the axis defined by the normal to the defined plane to obtain an initial point at which radical scanning can begin. This initial rotation can be used to define a start point (i.e., for rotation) so that a more appropriate scanning range can be obtained. FIG. 7 depicts an initial rotation of reference point 710 being rotated upward from the original reference point position shown in FIG. 6.

c. The voxel value of the reference point can then be retrieved at each point of the scan radius. If the retrieved value is below a defined threshold, then the point can be assumed to be outside the object. Thus, a transition to a value greater than the threshold value will indicate a surface point. The reverse is true if the current test point voxel value is higher than the threshold.

d. A forward scan can be performed to detect the required transition in order to obtain the surface point. This can be implemented, for example, by first rotating the reference point to difference positions on the plane, followed by the detection of transition at each of these new positions. FIG. 8 illustrates such forward scanning and detection of a voxel volume surface. FIG. 8, top frame, depicts transition detection of the voxel value of the reference point at various points of the scan radius 810. FIG. 8, bottom frame, depicts a transition being detected and a surface point 860 being found on volume object surface 830.

e. With the new surface point 860 obtained, the previous surface point (here start point 820, as it was the first surface point) can be used as the new reference point. This new reference point can then be rotated as described in (b) above. This is shown in FIG. 9, with reference point after rotation 910.

f. The next surface point can then be obtained using the procedure as described in (d) above. Thus, with reference to FIG. 9, the new reference point 910 can be used in a forward scan by rotating about the second surface point (860 in FIG. 8, the yellow surface point in FIG. 9). Thus, with reference to FIG. 10, by rotating the current reference point, transition detection can be performed at various points of the scan radius 1010. This results in a next detected surface point 1050, being now the second detected surface point.

9. (a)-(f) above can be repeated using each new surface point as a base for forward scanning until a surface line is generated from point A to point B. The results of this process are shown in FIG. 11, where numerous yellow surface points have been detected along the volume object surface, and each immediately prior detected surface point serves as the reference point for a forward scan at the current surface point. As shown in FIG. 11, processing is now performing transition detection from the fourth detected surface point, and is well on the way to end point 1140.

Exemplary Pseudocode for Voxel Object Surface Line Generation:

In exemplary embodiments of the present invention, the following pseudocode can, for example, be used to implement the determination of the point of approach.

Function name : GetPointOnVolumeSurface

```
Input:
    A ray represented by the tool direction
Output:
    flag - indicate if an intersection has occur between the ray and the volume object.
    intersectPt - indicate the surface point on the volume object if an intersection has occured
GetPointOnVolumeSurface ( )
    Compute the bounding box of the volume object
    If ray intersects bounding box of the volume object
        For each point along ray path starting from the bounding box intersection point
            If point is inside bounding box of volume object
                Retrieve the voxel value at the point
                If voxel value is greater than defined threshold 0.10 then
                    The surface point has been found
                    Return true
                End if
            Else
                Return false
            End if
        Next
    Else
        Return false
    End if
End function
```

Function name : GetNeighbourPoint

```
Input:
    prevPt : previous point
    curPt : current reference point
    normal: the plane normal
Output:
    flag - indicate if a neighbor point can be found
    nextPt - indicate the next neighbor point if it can be found
GetNeighborPoint ( )
    Compute the vector from prevPt to curPt
    Rotate the vector by 90 degree to get the start vector
    Set start point to be a distance away from the curPt along the direction define by the start
    vector
    Retrieve the voxel value at the start point
    If voxel value is greater than defined threshold of 0.10 then
        Intial state is defined to be inside volume object
    else
        Initial state is defined to be not inside volume object
    Define current scan radius equal to zero degree
    While scan radius is lesser than 270 degrees
        Set start vector to be 5 degree away from its current direction
        Set start point to be a distance away from the curPt along the direction define by the
        start vector
        Add 5 degree to the scan radius
        Retrieve voxel value at the start point
        If voxel value is greater than defined threshold of 0.10 then
            If initial state is not inside volume object then
                Surface point is found
                Return
            End if
        Else
            If initial state is inside volume object then
                Surface point is found
                Return
            End if
        End if
    Loop
End function
```

Function name : GetLineFromAToBOnVolumeSurface

```
Input:
    startPt : the start point of the surface line
    endPt : the end point of the surface line
    plane: the plane that will used to intersect the volume object
Output:
    flag - indicate that a surface line has been found from A to B
    line - a list containing the points on the surface of the volume object joining from A to B
GetLineFromAToBOnVolumeSurface ( )
    Add start point to the line list
    Get the vector from end point to start point
    Define the previous point to be a distance away from a start point along the direction of the
    above vector
    Do
        Use GetNeighborPoint ( ) function to get the next point along the line
        Add next point to line list
    Loop if next point is not close to end point
End function
```

Curve Measurement in “Noisy” Data Sets

Sometimes a voxel object may be noisy (i.e., there are voxels that are “outside” of the object but yet have a value that is greater than the determined threshold). This may result in the start point having been computed as being above the object surface rather than on the object surface itself. In such a situation, an initial scanning may result in the computation of the next point that is not on the object surface. This error can thus propagate to the rest of the scanning process and as a result it may not be possible to generate a surface line from the start point to the end point.

To solve this problem, in exemplary embodiments of the present invention, a multi-pass approach can, for example, be used. Instead of using a fixed threshold to determine the surface of an object and a fixed displacement to determine the reference point, a few values can be used instead. A line can then be generated based on the new set of values. This can be repeated until a combination of the values can successfully generate the surface line from start point to end point. However, too many passes can use more computation time and may slow user interaction. Thus, the number of passes can be limited to, for example, three passes and at each pass a different set of values can be used. A study based on existing data can be used to determine the different sets of values that can work in most situations.

Exemplary Measurement Results

Surface measurement according to an exemplary embodiment of the present invention was performed on test data consisting of a spherical voxel object as well as a spherical mesh object. An estimation of the diameter of the sphere was made by performing a linear measurement at the two extreme points of the sphere. From this measurement the diameter of the sphere was found to be approximately 24.46 mm. The circumference of the sphere was thus computed as:
Circumference of sphere=Pi*diameter of sphere=3.141×24.46=76.84 mm

Thus, half the circumference of the example sphere should be equal to 76.84×0.5=38.42 mm. A surface measurement was performed on the sphere object to measure half the circumference, and an approximate value of 38.57 mm was obtained The same measurement on the skin object gave an approximate value of 38.94 mm. thus, in this test, the methods of the present invention were found to be reasonably accurate.

Exemplary Systems

The present invention can be implemented in software run on a data processor, in hardware in one or more dedicated chips, or in any combination of the above. Exemplary systems can include, for example, a stereoscopic display, a data processor, one or more interfaces to which are mapped interactive display control commands and functionalities, one or more memories or storage devices, and graphics processors and associated systems. For example, the Dextroscope™ and Dextrobeam™ systems manufactured by Volume Interactions Pte Ltd of Singapore, running the RadioDexter™ software, or any similar or functionally equivalent 3D data set interactive visualization systems, are systems on which the methods of the present invention can easily be implemented.

Exemplary embodiments of the present invention can be implemented as a modular software program of instructions which may be executed by an appropriate data processor, as is or may be known in the art, to implement a preferred exemplary embodiment of the present invention. The exemplary software program may be stored, for example, on a hard drive, flash memory, memory stick, optical storage medium, or other data storage devices as are known or may be known in the art. When such a program is accessed by the CPU of an appropriate data processor and run, it can perform, in exemplary embodiments of the present invention, methods as described above of displaying a 3D computer model or models of a tube-like structure in a 3D data display system.

While the present invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

What is claimed:

1. A method of generating a line on a curved surface, comprising:
preprocessing a triangle mesh data structure;
constructing a grid data structure for the triangle mesh object;
representing a relationship of triangles and vertices;
determining boundary edges and vertices;
computing surface points; and
generating a surface line connecting them.

2. The method of claim 1, wherein the surface line is a closed curve.

3. The method of claim 2, wherein the curve is used to cut out a region from the mesh object.

4. A method of generating a surface line from points A to B on a voxel object, comprising:
defining a reference point based upon a start point A and the direction of a vector from start point A to end point B;
rotating the reference point along an axis defined by the normal of a defined plane to obtain an initial surface point;
detecting a required transition at various points of the scan radius to find the initial surface point;
using the initial surface point as a new reference point;
repeating the above process until a surface line has been generated from point A to point B.

5. The method of claim 4, wherein the reference point is defined as a point a small displacement away from the start point.

6. The method of claim 4, wherein the defined plane is a plane containing the start point, the end point and a user's eye position.

7. The method of claim 4, wherein the required transition is one of voxel intensity representing moving form a voxel not on the surface of the object to a voxel on the surface of the object.

8. The method of claim 5, wherein the small displacement is user defined.

9. A computer program product comprising a computer usable medium having computer readable program code means embodied therein, the computer readable
program code means in said computer program product comprising means for causing a computer to:
define a reference point based upon a start point A and the direction of a vector from start point A to end point B;
rotate the reference point along an axis defined by the normal of a defined plane to obtain an initial surface point;
detect a required transition at various points of the scan radius to find the initial surface point;
use the initial surface point as a new reference point;
repeat the above process until a surface line has been generated from point A to point B.

10. The computer program product of claim 9, wherein the reference point is defined as a point a small displacement away from the start point.

11. The computer program product of claim 9, wherein the defined plane is a plane containing the start point, the end point and a user's eye position.

12. The computer program product of claim 9, wherein the required transition is one of voxel intensity representing moving form a voxel not on the surface of the object to a voxel on the surface of the object.

13. The computer program product of claim 10, wherein the small displacement is user defined.

14. The computer program product of claim 9, wherein start point A and end point B are user defined.

15. The method of claim 4, wherein start point A and end point B are user defined.

16. A method of finding a curved line along an arbitrary curved 3D surface, comprising:
defining a start point and an end point each contained in a 3D curved surface in a 3D space;
finding the line in the 3D space between the start point and the end point;
defining a plane containing the line and a user viewpoint;
defining a line segment extending an incremental length from the start point in the direction normal to the curved surface;
rotating the line segment about an axis normal to the plane towards the end point until a point on the 3D curved surface is located;
repeating the process using the located point on the 3D surface as a new start point until the line segment intersects the end point.

17. The method of claim 16, wherein the point on the 3D surface is located by detecting a transition within the 3D space between points not on the 3D surface to a point on the 3D surface.

18. The method of claim 18, wherein the transition is detected by measuring a property of each point within the 3D space which can distinguish between points within and not within the 3D curved surface.

19. The method of claim 16, wherein the rotation is implemented using a defined increment.

20. The method of claim 19, wherein said rotational increment varies with position within the 3D data set.

21. The method of claim 16, wherein the curved line is used to measure volumes contained by some or all of the curved 3D surface.

22. A method of cutting a mesh structure by an arbitrary closed curve, comprising:
defining a mesh structure in terms of a set of triangles and vertices;
drawing an arbitrary closed curve through the mesh structure;
for each triangle that the curve intersects determine an inner and an outer portion of the triangle divided by a segment of the curve; and
retriangulating the mesh structure to only include the inner portions of the intersected triangles.
